(19) United States
(12) Patent Application Publication
(10) Pub. No.: US 2026/0020036 A1
(43) Pub. Date: Jan. 15, 2026

(54) DEMODULATION REFERENCE SIGNAL DISTINCTION TO SUPPORT DOWNLINK CHANNEL COMBINING

(71) Applicant: QUALCOMM Incorporated, San Diego, CA (US)

(72) Inventors: In-Soo KIM, San Diego, CA (US); Yan ZHOU, San Diego, CA (US); Jing SUN, San Diego, CA (US); Tao LUO, San Diego, CA (US); Jing JIANG, San Diego, CA (US); Mostafa KHOSHNEVISAN, San Diego, CA (US)

(21) Appl. No.: 18/768,531

(22) Filed: Jul. 10, 2024

(51) Int. Cl. H04W 72/231; H04L 5/00; H04W 72/1273

(52) U.S. Cl. CPC H04W 72/231; H04L 5/0051; H04W 72/1273

(57) ABSTRACT

Methods, systems, and devices for wireless communications are described herein. A user equipment (UE) may utilize system information signaling to initiate and maintain synchronized communications. The UE may monitor a first physical downlink control channel (PDCCH) search space and a second PDCCH search space for downlink control information (DCI) associated with a channel-specific demodulation reference signal (DMRS) scrambling identifier. In some aspects, the channel-specific DMRS scrambling identifier may identify a remaining minimum system information (RMSI)-specific PDCCH, or other PDCCH types. The UE may receive DCI associated with the channel-specific DMRS scrambling identifier according to the monitoring, such that the DCI is received in accordance with a combination of a first DCI candidate of the first PDCCH search space and a second DCI candidate of the second PDCCH search space. The UE may then receive a physical downlink shared channel (PDSCH) transmission in accordance with scheduling included in the DCI.

### FIELD OF TECHNOLOGY

The following relates to wireless communications, including demodulation reference signal (DMRS) distinction to support downlink channel combining.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include monitoring a first physical downlink control channel (PDCCH) search space and a second PDCCH search space for downlink control information (DCI) associated with a channel-specific demodulation reference signal (DMRS) scrambling identifier, receiving DCI associated with the channel-specific DMRS scrambling identifier according to the monitoring, where the DCI is received in accordance with a combination of a first DCI candidate of the first PDCCH search space and a second DCI candidate of the second PDCCH search space, and receiving a physical downlink shared channel (PDSCH) transmission in accordance with the DCI.

A UE for wireless communications is described. The UE may include one or more memories storing processor executable code, and one or more processors coupled with the one or more memories. The one or more processors may individually or collectively be operable to execute the code to cause the UE to monitor a first PDCCH search space and a second PDCCH search space for DCI associated with a channel-specific DMRS scrambling identifier, receive DCI associated with the channel-specific DMRS scrambling identifier according to the monitoring, where the DCI is received in accordance with a combination of a first DCI candidate of the first PDCCH search space and a second DCI candidate of the second PDCCH search space, and receive an PDSCH transmission in accordance with the DCI.

Another UE for wireless communications is described. The UE may include means for monitoring a first PDCCH search space and a second PDCCH search space for DCI associated with a channel-specific DMRS scrambling identifier, means for receiving DCI associated with the channel-specific DMRS scrambling identifier according to the monitoring, where the DCI is received in accordance with a combination of a first DCI candidate of the first PDCCH search space and a second DCI candidate of the second PDCCH search space, and means for receiving an PDSCH transmission in accordance with the DCI.

A non-transitory computer-readable medium storing code for wireless communications is described. The code may include instructions executable by one or more processors to monitor a first PDCCH search space and a second PDCCH search space for DCI associated with a channel-specific DMRS scrambling identifier, receive DCI associated with the channel-specific DMRS scrambling identifier according to the monitoring, where the DCI is received in accordance with a combination of a first DCI candidate of the first PDCCH search space and a second DCI candidate of the second PDCCH search space, and receive an PDSCH transmission in accordance with the DCI.

In some examples of the method, UEs, and non-transitory computer-readable medium described herein, monitoring the first PDCCH search space and the second PDCCH search space may include operations, features, means, or instructions for monitoring the first PDCCH search space and the second PDCCH search space for RMSI, where the channel-specific DMRS scrambling identifier indicates that the first PDCCH search space and the second PDCCH search space may be associated with receiving the RMSI.

In some examples of the method, UEs, and non-transitory computer-readable medium described herein, the channel-specific DMRS scrambling identifier includes a first type of DMRS scrambling identifier that indicates RMSI (RMSI)-specific PDCCH and the method, apparatuses, and non-transitory computer-readable medium may include further operations, features, means, or instructions for monitoring a third PDCCH search space for DCI associated with a second type of DMRS scrambling identifier that may be different from the first type of DMRS scrambling identifier, where the second type of DMRS scrambling identifier indicates one or more PDCCHs that may be different from the RMSI-specific PDCCH.

Some examples of the method, UEs, and non-transitory computer-readable medium described herein may further include operations, features, means, or instructions for determining that the channel-specific DMRS scrambling identifier indicates RMSI-specific PDCCH in accordance with a correlation between a received DMRS signal sequence and a DMRS sequence associated with the channel-specific DMRS scrambling identifier exceeding a correlation threshold.

In some examples of the method, UEs, and non-transitory computer-readable medium described herein, the first DCI candidate and the second DCI candidate include a subset of DCI candidates of a set of multiple DCI candidates associated with receiving RMSI, and the channel-specific DMRS scrambling identifier corresponds to the subset of DCI candidates.

In some examples of the method, UEs, and non-transitory computer-readable medium described herein, the channel-specific DMRS scrambling identifier corresponds to the subset of DCI candidates based on the DCI being received in accordance with the combination of the subset of DCI candidates.

Some examples of the method, UEs, and non-transitory computer-readable medium described herein may further include operations, features, means, or instructions for receiving a master information block (MIB) including at least one field that indicates whether first content of the first DCI candidate of the first PDCCH search space may be identical to second content of the second DCI candidate of the second PDCCH search space.

In some examples of the method, UEs, and non-transitory computer-readable medium described herein, the at least one field of the MIB includes a single bit that indicates whether the first content may be identical to the second content.

In some examples of the method, UEs, and non-transitory computer-readable medium described herein, the channel-specific DMRS scrambling identifier includes a RMSI PDCCH-specific DMRS scrambling identifier associated with a first cell and the method, apparatuses, and non-transitory computer-readable medium may include further operations, features, means, or instructions for monitoring a third PDCCH search space for DCI associated with a cell-specific DMRS scrambling identifier associated with a second cell, where the RMSI PDCCH-specific DMRS scrambling identifier may be different in value from the cell-specific DMRS scrambling identifier.

In some examples of the method, UEs, and non-transitory computer-readable medium described herein, the RMSI PDCCH-specific DMRS scrambling identifier may be selected from a first set of identifier values and the cell-specific DMRS scrambling identifier may be selected from a second set of identifier values and the first set of identifier values and the second set of identifier values may be non-overlapping.

In some examples of the method, UEs, and non-transitory computer-readable medium described herein, the channel-specific DMRS scrambling identifier may be associated with a first cell of the UE, and may be selected from a set of multiple channel-specific DMRS scrambling identifiers that excludes one or more channel-specific DMRS scrambling identifiers associated with one or more neighboring cells of the first cell.

Some examples of the method, UEs, and non-transitory computer-readable medium described herein may further include operations, features, means, or instructions for transmitting a cell measurement report including one or more measurements for the first cell and the one or more neighboring cells of the first cell and receiving, in accordance with the cell measurement report, an indication of the channel-specific DMRS scrambling identifier associated with the first cell.

In some examples of the method, UEs, and non-transitory computer-readable medium described herein, buffering, prior to combining and decoding the first DCI candidate and the second DCI candidate, one or more frequency domain in-phase/quadrature (I/Q) samples that may be candidates for the PDSCH scheduled by the first DCI candidate or the second DCI candidate.

In some examples of the method, UEs, and non-transitory computer-readable medium described herein, the first DCI candidate, the second DCI candidate, or both, indicate a scheduling of the one or more frequency domain I/Q samples for the PDSCH that spans a portion of a downlink bandwidth part.

In some examples of the method, UEs, and non-transitory computer-readable medium described herein, the channel-specific DMRS scrambling identifier includes a first channel-specific DMRS scrambling identifier associated with the first PDCCH search space, and monitoring the first PDCCH search space and the second PDCCH search space may include operations, features, means, or instructions for monitoring the first PDCCH search space for DCI associated with the first channel-specific DMRS scrambling identifier and the second PDCCH search space for DCI associated with a second channel-specific DMRS scrambling identifier, where the first channel-specific DMRS scrambling identifier may be different from the second channel-specific DMRS scrambling identifier based on the first PDCCH search space and the second PDCCH search space including a same PDCCH search space.

In some examples of the method, UEs, and non-transitory computer-readable medium described herein, the channel-specific DMRS scrambling identifier includes a first channel-specific DMRS scrambling identifier associated with the first PDCCH search space, and monitoring the first PDCCH search space and the second PDCCH search space may include operations, features, means, or instructions for monitoring the first PDCCH search space for DCI associated with the first channel-specific DMRS scrambling identifier and the second PDCCH search space for DCI associated with a second channel-specific DMRS scrambling identifier, where the first channel-specific DMRS scrambling identifier may be different from the second channel-specific DMRS scrambling identifier based on the first PDCCH search space and the second PDCCH search space being associated with a same control resource set.

A method for wireless communications by a network entity is described. The method may include outputting, to a UE, DCI associated with a channel-specific DMRS scrambling identifier, where the DCI is output in accordance with a combination of a first DCI candidate of a first PDCCH search space and a second DCI candidate of a second PDCCH search space and outputting an PDSCH transmission in accordance with the DCI.

A network entity for wireless communications is described. The network entity may include one or more memories storing processor executable code, and one or more processors coupled with the one or more memories. The one or more processors may individually or collectively be operable to execute the code to cause the network entity to output, to a UE, DCI associated with a channel-specific DMRS scrambling identifier, where the DCI is output in accordance with a combination of a first DCI candidate of a first PDCCH search space and a second DCI candidate of a second PDCCH search space and output an PDSCH transmission in accordance with the DCI.

Another network entity for wireless communications is described. The network entity may include means for outputting, to a UE, DCI associated with a channel-specific DMRS scrambling identifier, where the DCI is output in accordance with a combination of a first DCI candidate of a first PDCCH search space and a second DCI candidate of a second PDCCH search space and means for outputting an PDSCH transmission in accordance with the DCI.

A non-transitory computer-readable medium storing code for wireless communications is described. The code may include instructions executable by one or more processors to output, to a UE, DCI associated with a channel-specific DMRS scrambling identifier, where the DCI is output in accordance with a combination of a first DCI candidate of a first PDCCH search space and a second DCI candidate of a second PDCCH search space and output an PDSCH transmission in accordance with the DCI.

In some examples of the method, network entities, and non-transitory computer-readable medium described herein, the channel-specific DMRS scrambling identifier indicates that the first PDCCH search space and the second PDCCH search space may be associated with receiving RMSI.

In some examples of the method, network entities, and non-transitory computer-readable medium described herein, the channel-specific DMRS scrambling identifier includes a first type of DMRS scrambling identifier that indicates RMSI-specific PDCCH and the method, apparatuses, and non-transitory computer-readable medium may include further operations, features, means, or instructions for outputting DCI associated with a second type of DMRS scrambling identifier that may be different from the first type of DMRS scrambling identifier, where the second type of DMRS scrambling identifier indicates one or more PDCCHs that may be different from the RMSI-specific PDCCH.

In some examples of the method, network entities, and non-transitory computer-readable medium described herein, the first DCI candidate and the second DCI candidate include a subset of DCI candidates of a set of multiple DCI candidates associated with outputting RMSI, and the channel-specific DMRS scrambling identifier corresponds to the subset of DCI candidates.

In some examples of the method, network entities, and non-transitory computer-readable medium described herein, the channel-specific DMRS scrambling identifier corresponds to the subset of DCI candidates based on the DCI being output in accordance with the combination of the subset of DCI candidates.

Some examples of the method, network entities, and non-transitory computer-readable medium described herein may further include operations, features, means, or instructions for outputting a MIB including at least one field that indicates whether first content of the first DCI candidate of the first PDCCH search space may be identical to second content of the second DCI candidate of the second PDCCH search space, where the at least one field of the MIB includes a single bit that indicates whether the first content may be identical to the second content.

In some examples of the method, network entities, and non-transitory computer-readable medium described herein, the channel-specific DMRS scrambling identifier includes a RMSI PDCCH-specific DMRS scrambling identifier associated with a first cell and the RMSI PDCCH-specific DMRS scrambling identifier may be different in value from a cell-specific DMRS scrambling identifier associated with a second cell.

In some examples of the method, network entities, and non-transitory computer-readable medium described herein, the channel-specific DMRS scrambling identifier may be associated with a first cell associated with the network entity and the method, apparatuses, and non-transitory computer-readable medium may include further operations, features, means, or instructions for selecting the channel-specific DMRS scrambling identifier from a set of multiple channel-specific DMRS scrambling identifiers that excludes one or more channel-specific DMRS scrambling identifiers associated with one or more neighboring cells of the first cell.

Some examples of the method, network entities, and non-transitory computer-readable medium described herein may further include operations, features, means, or instructions for obtaining a cell measurement report including one or more measurements for the first cell and the one or more neighboring cells of the first cell and outputting, in accordance with the cell measurement report, an indication of the channel-specific DMRS scrambling identifier associated with the first cell.

Some examples of the method, network entities, and non-transitory computer-readable medium described herein may further include operations, features, means, or instructions for obtaining an indication of the channel-specific DMRS scrambling identifier via one or more backhaul links associated with the network entity.

In some examples of the method, network entities, and non-transitory computer-readable medium described herein, the DCI indicates a scheduling of one or more frequency domain I/Q samples for the PDSCH that spans a portion of a downlink bandwidth part.

In some examples of the method, network entities, and non-transitory computer-readable medium described herein, the channel-specific DMRS scrambling identifier includes a first channel-specific DMRS scrambling identifier associated with the first PDCCH search space and the first channel-specific DMRS scrambling identifier may be different from the second channel-specific DMRS scrambling identifier based on the first PDCCH search space and the second PDCCH search space including a same PDCCH search space, or based on the first PDCCH search space and the second PDCCH search space being associated with a same control resource set.

Details of one or more implementations of the subject matter described herein in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that supports demodulation reference signal (DMRS) distinction to support downlink channel combining in accordance with one or more aspects of the present disclosure.

FIG. 3 shows an example of remaining minimum system information (RMSI) physical downlink control channel (PDCCH)-specific DMRS scrambling identifier implementations that support DMRS distinction to support downlink channel combining in accordance with one or more aspects of the present disclosure.

FIG. 4 shows an example of a wireless communications system that supports DMRS distinction to support downlink channel combining in accordance with one or more aspects of the present disclosure.

FIGS. 5 and 6 show examples of RMSI PDCCH detection configurations that support DMRS distinction to support downlink channel combining in accordance with one or more aspects of the present disclosure.

FIG. 7 shows an example of a process flow that supports DMRS distinction to support downlink channel combining in accordance with one or more aspects of the present disclosure.

FIGS. 8 and 9 show block diagrams of devices that support DMRS distinction to support downlink channel combining in accordance with one or more aspects of the present disclosure.

FIG. 10 shows a block diagram of a communications manager that supports DMRS distinction to support downlink channel combining in accordance with one or more aspects of the present disclosure.

FIG. 11 shows a diagram of a system including a device that supports DMRS distinction to support downlink channel combining in accordance with one or more aspects of the present disclosure.

FIGS. 12 and 13 show block diagrams of devices that support DMRS distinction to support downlink channel combining in accordance with one or more aspects of the present disclosure.

FIG. 14 shows a block diagram of a communications manager that supports DMRS distinction to support downlink channel combining in accordance with one or more aspects of the present disclosure.

FIG. 15 shows a diagram of a system including a device that supports DMRS distinction to support downlink channel combining in accordance with one or more aspects of the present disclosure.

FIGS. 16 and 17 show flowcharts illustrating methods that support demodulation reference signal distinction to support downlink channel combining in accordance with one or more aspects of the present disclosure.

### DETAILED DESCRIPTION

A wireless communications system may utilize system information signaling to enable initial access and synchronization for user equipment (UEs), and to maintain reliable communications. System information signaling may include master information block (MIB) signaling, which may be classified as “minimum system information,” and other system information block (SIB) signaling, which may be classified as “other system information,” which a UE may use to gain access to a cell and perform ongoing communications. Minimum system information includes a MIB, which the UE receives via a periodic broadcast, and a first SIB (e.g., SIB1), which the UE receives via a downlink shared channel (e.g., a physical downlink shared channel (PDSCH)) scheduled by a downlink control channel (e.g., a physical downlink control channel (PDCCH)). In some aspects, the MIB may include initial system information that the UE uses to establish communication via the cell, while SIB1 includes any remaining minimum system information (RMSI) indicating additional communication parameters or other information for communicating with via the cell.

To enhance the coverage of RMSI PDCCH and the RMSI PDSCH, the UE may combine the RMSI PDCCH and the RMSI PDSCH across a transmission time interval associated with the RMSI broadcast (assuming that the different RMSI transmissions have identical content). In some cases, however, the UE may be unaware of which PDCCH candidates to combine, since the UE may be unable to distinguish an RMSI PDCCH candidate from other PDCCH candidate types (such as a paging PDCCH candidate, among other PDCCH candidate types). Additionally, or alternatively, the UE be unaware of a location where the RMSI PDSCH is scheduled until the PDCCH has been decoded, which may cause the UE to buffer excess PDSCH candidates, causing memory challenges and reduced energy efficiency for the UE.

The UE may support various different techniques to distinguish the RMSI PDCCH from other types of PDCCHs, and to enable the UE to know where the RMSI PDSCH has been scheduled, even if the RMSI PDCCH has been detected, but not yet decoded. For example, a network entity may assign an RMSI PDCCH-specific DMRS scrambling identifier to RMSI PDCCHs (or at least a subset of the RMSI PDCCHs) so that the UE may distinguish the RMSI PDCCH from other types of PDCCHs, such as paging PDCCHs or other types of scheduling PDCCHs. Additionally, or alternatively, the network entity may include an indication in the MIB (e.g., a one bit indication) that allows the UE to determine whether the content of the RMSI PDCCH is identical during the RMSI transmission time interval, so that the UE may be able to more accurately know whether to combine the RMSI PDCCH candidates. In some other examples, the network entity may assign the RMSI PDCCH-specific DMRS scrambling identifier to be different from other cell identifiers of neighboring cells to reduce the likelihood of collision between the RMSI PDCCH-specific DMRS scrambling identifier at one cell and UE-specific DMRS scrambling identifier at another cell.

Aspects of the disclosure may be implemented to realize one or more potential advantages. For example, the UE may use the RMSI PDCCH-specific DMRS scrambling identifier to accurately identify RMSI PDCCH and distinguish the RMSI PDCCH from other types of PDCCHs, which may allow for more efficient UE operation. Additionally, or alternatively, the techniques described herein may allow for efficient PDCCH combination across different PDCCH scheduling types, based on the assignment of different PDCCH-specific DMRS scrambling identifiers. In addition, the techniques described herein may reduce the frequency domain buffering burden and reduce power expenditure based on additional scheduling information associated with RMSI PDCCH candidates.

Aspects of the disclosure are initially described herein in the context of wireless communications systems. Aspects of the disclosure are further illustrated by and described herein with reference to PDCCH-specific DMRS scrambling identifier implementations, RMSI PDCCH detection configurations, a process flow, apparatus diagrams, system diagrams, and flowcharts that relate to DMRS distinction to support downlink channel combining.

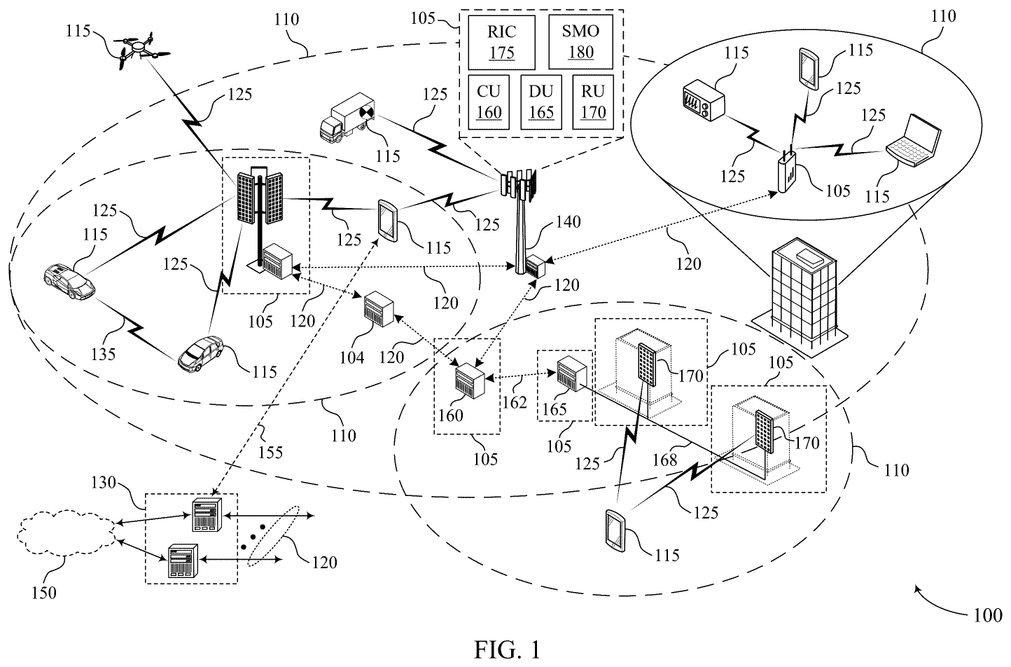

FIG. 1 shows an example of a wireless communications system 100 that supports DMRS distinction to support downlink channel combining in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a geographic coverage area 110 over which the UEs 115 and the network entity 105 may establish the communication link(s) 125. The geographic coverage area 110 may be an example of a geographic area over which a network entity 105 and a UE 115 may support the communication of signals according to one or more radio access technologies (RATs).

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described herein as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving geographic coverage area, such as the geographic coverage area 110. In some examples, geographic coverage areas 110 (e.g., different geographic coverage areas) associated with different technologies may overlap, but the geographic coverage areas 110 (e.g., different geographic coverage areas) may be supported by the same network entity (e.g., a network entity 105). In some other examples, overlapping geographic coverage areas, such as a geographic coverage area 110, associated with different technologies may be supported by different network entities (e.g., the network entities 105). The wireless communications system 100 may include, for example, a heterogeneous network in which different types of the network entities 105 support communications for geographic coverage areas 110 (e.g., different geographic coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the geographic coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the geographic coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 may generate a PDCCH DMRS sequence based on the length-31 Gold sequence, which may be initialized based on the physical cell identifier (PCI) for a CORESET0 (e.g., such that various types of PDCCHs that share CORESET0 may also share the same cell-specific DMRS scrambling identifier). In some aspects, a UE 115 may assume or determine that a reference-signal sequence rₗ(m) for OFDM symbol l may be defined by

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) .$$

where the pseudo-random sequence c (i) is defined in clause 5.2.1. The pseudo-random sequence generator may be initialized with:

$${c}_{init} = ( {2}^{17} ( {N}_{symb}^{slot} {n}_{s , f}^{μ} + l + 1 ) ( 2 {N}_{ID} + 1 ) + 2 {N}_{ID} ) mod {2}^{31}$$

where l is the OFDM symbol number within the slot,

$${n}_{s , f}^{μ}$$

is the slot number within a frame, and N_{ID}∈{0, 1, . . . , 65535} is given by the higher-layer parameter pdcch-DMRS-ScramblingID if provided, and N_{ID}∈{0, 1, . . . , 65535} is given by the higher-layer parameter pdcch-DMRS-ScramblingID if configured for a common search space in a common MBS frequency resource, or

$${N}_{ID} = {N}_{ID}^{cell}$$

otherwise.

System information signaling for the wireless communications system 100 may include MIB signaling and other SIB signaling, which a UE 115 may use to gain access to a cell and perform ongoing communications. Minimum system information includes a MIB, which the UE 115 receives via a periodic broadcast, and a first SIB (e.g., SIB1), which the UE 115 receives via a downlink shared channel scheduled by a downlink control channel. In some aspects, the MIB may include “critical” system information that the UE uses for communication, while SIB1 includes any RMSI.

In order to enhance the coverage of RMSI PDCCH and the RMSI PDSCH, the UE 115 may combine the RMSI PDCCH and the RMSI PDSCH across a transmission time interval associated with the RMSI broadcast (assuming that the different RMSI transmissions have identical content). In some cases, however, the UE 115 may be unaware of which PDCCH candidates to combine, since the UE 115 may be unable to distinguish an RMSI PDCCH candidate from other PDCCH candidate types (such as a paging PDCCH candidate, among other PDCCH candidate types). Additionally, or alternatively, the UE 115 be unaware of a location where the RMSI PDSCH is scheduled until the PDCCH has been decoded, which may cause the UE 115 to buffer excess PDSCH candidates, causing memory challenges and reduced energy efficiency for the UE.

In some aspects, the UE 115 may support various different techniques to distinguish the RMSI PDCCH from other types of PDCCHs, and to enable the UE 115 to know where the RMSI PDSCH has been scheduled, even if the RMSI PDCCH has been detected, but not yet decoded. For example, a network entity 105 may assign an RMSI PDCCH-specific DMRS scrambling identifier to RMSI PDCCHs (or at least a subset of the RMSI PDCCHs) so that the UE 115 may distinguish the RMSI PDCCH from other types of PDCCHs, such as paging PDCCHs or other types of scheduling PDCCHs. Additionally, or alternatively, the network entity 105 may include an indication in the MIB (e.g., a one bit indication) that allows the UE 115 to determine whether the content of the RMSI PDCCH is identical during the RMSI transmission time interval, so that the UE 115 may be able to more accurately know whether to combine the RMSI PDCCH candidates.

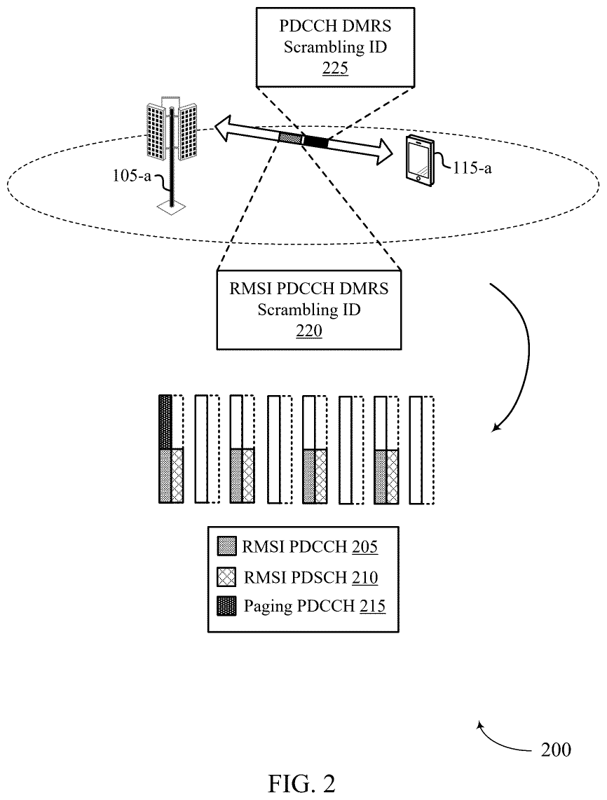

FIG. 2 shows an example of a wireless communications system 200 that supports DMRS distinction to support downlink channel combining in accordance with one or more aspects of the present disclosure. For example, the wireless communications system 200 illustrates communications between a network entity 105-a, and a UE 115-a, each of which may be examples of network entities 105 and UEs 115 described herein with reference to FIG. 1. In some aspects, the wireless communications system 200 may be an example of a new radio (NR) communications system, or any other radio access technology supporting communication over a wireless air interface.

In some implementations, the network entity 105-a may deliver (e.g., transmit, broadcast, output) various different types of system information signaling to the UE 115-a, that the UE 115-a may use to perform initial access and synchronization with the wireless communications system 200, and to maintain ongoing access. In some examples, the system information may include a MIB, which the network entity 105-a may output via a periodic broadcast of a physical broadcast channel (PBCH), along with other system information, such as SIB signaling. In some aspects, the MIB may be classified as “minimum system information,” and includes a “minimum” amount of information that the UE 115-a uses to connect and synchronize with the network entity, while the SIB signaling may include “other system information,” or remaining minimum system information (RMSI) that the UE 115-a may use for ongoing communication.

In some cases, the SIB signaling may include a first SIB (e.g., SIB1 or RMSI), which the UE 115-a may receive via periodic broadcast of a downlink shared channel (e.g., a PDSCH) scheduled by a downlink control channel (e.g., a PDCCH), which may be associated with a type-0 common search space (CSS). Additionally, or alternatively, the SIB signaling may include other SIBs (e.g., SIBs 2-9, or other system information (OSI)), which the UE 115-a may receive via on-demand delivery of the PDSCH scheduled by the PDCCH, which may be associated with a type-0A CSS.

In some aspects, the broadcast nature of the RMSI PDCCH 205, the transport block size of the RMSI PDCCH 205, or both, may introduce coverage limitations in high frequency bands (e.g., frequency range-2 (FR2) and beyond) and other frequency bands (e.g., FR1) of the wireless communications system based on coarse beam directions associated with the broadcast signaling, among other factors. For example, the network entity 105-a may periodically broadcast the RMSI PDCCH 205 based on a predefined SSB multiplexing pattern every 160-ms transmission time interval (TTI) for RMSI.

In a first SSB multiplexing pattern (e.g., SSB multiplexing pattern 1), the RMSI PDCCH and the RMSI PDSCH are time domain multiplexed with the SSB in FR1 and FR2. In the first SSB multiplexing pattern, the SSB subcarrier spacing and the RMSI PDSCH and RMSI PDCCH subcarrier spacing may be represented by (120, 60) kHz, with a 1-symbol RMSI PDCCH and a 2 symbol RMSI PDSCH. In a second SSB multiplexing pattern (e.g., SSB multiplexing pattern 2) the RMSI PDCCH 205 and the RMSI PDSCH are time domain multiplexed, frequency domain multiplexed, or both, with the SSB in FR2. In the second SSB multiplexing pattern, the SSB subcarrier spacing and the RMSI PDSCH and RMSI PDCCH subcarrier spacing may be represented by (240, 120) kHz, with a 1-symbol RMSI PDCCH and a 2 symbol RMSI PDSCH. In a third SSB multiplexing pattern (e.g., SSB multiplexing pattern 3) the RMSI PDCCH and the RMSI PDSCH may be frequency domain multiplexed with the SSB in FR2. In the third SSB multiplexing pattern, the SSB subcarrier spacing and the RMSI PDSCH and RMSI PDCCH subcarrier spacing may be represented by (120, 120) kHz, with a 2-symbol RMSI PDCCH and a 2 symbol RMSI PDSCH. For different implementations of the RMSI signaling, the network entity may use a DCI format 1_0 scrambled with a system information-radio network temporary identifier (SI-RNTI) to schedule the RMSI PDSCH.

In some aspects, the second SSB multiplexing pattern and the third SSB multiplexing pattern, the RMSI PDSCH may be confined within the SSB, (e.g., with the quantity of RMSI PDSCH symbols being less than or equal to 2 symbols) which may introduce a coverage bottleneck for the RMSI PDSCH in FR2.

In order to enhance the coverage of RMSI PDCCH 205 and the RMSI PDSCH 210, the UE 115-a may combine the RMSI PDCCH 205/PDSCH across a 160 ms TTI associated with the RMSI broadcast (assuming that the different RMSI transmissions have identical content, and assuming the first SSB multiplexing pattern). In some cases, however, the UE 115-a may be unaware of which PDCCH candidates to combine, since the UE 115-a may be unable to distinguish a candidate for the RMSI PDCCH 205 from other PDCCH candidate types (such as a paging PDCCH candidate 215, among other PDCCH candidate types). For example, in some cases, the RMSI PDCCH 205 may share the same DCI format with various types of other PDCCHs (e.g., the RMSI PDCCH 205 may share DCI format 1_0 with the paging radio network temporary identifier (P-RNTI) for the paging PDCCH candidate 215, random access-radio network temporary identifier (RA-RNTI) for message 2, temporary cell-radio network temporary identifier (TC-RNTI) for message 4, SI-RNTI for the other system information PDCCH). In addition, the RMSI PDCCH 205 may share the same search space (e.g., control resource set (CORESET)) with various other types of PDCCHs, (e.g., the RMSI PDCCH 205 and the paging PDCCH candidate 215 may share the same CORESET0 and search space 0).

Additionally, or alternatively, the UE 115-a may be unaware of a scheduled location of the RMSI PDSCH 210 until the UE 115-a decodes the PDCCH, which may cause various challenges for the UE. For example, if the RMSI PDCCH 205 is combined and decoded at a fourth transmission occasion, the UE may miss combining the RMSI PDSCHs at the first, second, and third transmission occasions unless the UE 115-a has buffered the entire initial bandwidth part (BWP). This process of buffering the entire initial BWP across multiple transmission occasions, however, may be relatively energy inefficient for the UE 115-a, and may be inefficient use of UE memory.

The wireless communications system 200 may support various different techniques that allow the UE 115-a to effectively distinguish the RMSI PDCCH 205 from other types of PDCCHs, and that enable the UE 115-a to know where the RMSI PDSCH 210 has been scheduled, even if the RMSI PDCCH 205 has been detected by the UE 115-a, but not yet decoded. For example, the network entity 105-a may assign an RMSI PDCCH-specific DMRS scrambling identifier 220 to RMSI PDCCHs (or at least a subset of the RMSI PDCCHs) so that the UE 115-a may distinguish the RMSI PDCCH 205 from other types of PDCCHs that may have other PDCCH DMRS scrambling identifiers 225, such as paging PDCCHs or other types of scheduling PDCCHs. In such examples, the UE 115-a may be able to determine which PDCCH candidates to combine among the detected (but not yet decoded) PDCCH candidates at CORESET0 or search space 0. In some examples, the network entity 105-a may provide (e.g., signal, include) an indication in the MIB (e.g., a one bit indication) that allows the UE 115-a to determine whether the content of the multiple RMSI PDCCH 205 is identical during the RMSI TTI, so that the UE 115-a may be able to more accurately determine whether to combine the RMSI PDCCH 205 candidates.

In some other examples, the network entity 105-a may assign the RMSI PDCCH-specific DMRS scrambling identifier to be different from other cell identifiers of neighboring cells to reduce the likelihood of collision between the RMSI PDCCH-specific DMRS scrambling identifier at one cell and UE-specific DMRS scrambling identifier at another cell. Additionally, or alternatively, the network entity 105-a may indicate coarse scheduling info of the RMSI PDSCH with RMSI PDCCH candidate indices, such that if the UE 115-a detects a particular RMSI PDCCH candidate, the UE 115-a may be able to deduce or determine scheduling information of the RMSI PDSCH. In such examples, the UE 115-a may buffer frequency domain in-phase quadrature (I/Q) samples at locations where the RMSI PDCCH (potentially) schedules the RMSI PDSCH, so that the UE 115-a may combine the RMSI PDSCH when the UE 115-a decodes the RMSI PDCCH (and obtains the scheduling info of the RMSI PDCCH, including frequency domain resource allocation and time domain resource allocation (FDRA/TDRA) information, virtual resource block-to physical resource block (VRB-to-PRB) mapping information, and other scheduling information).

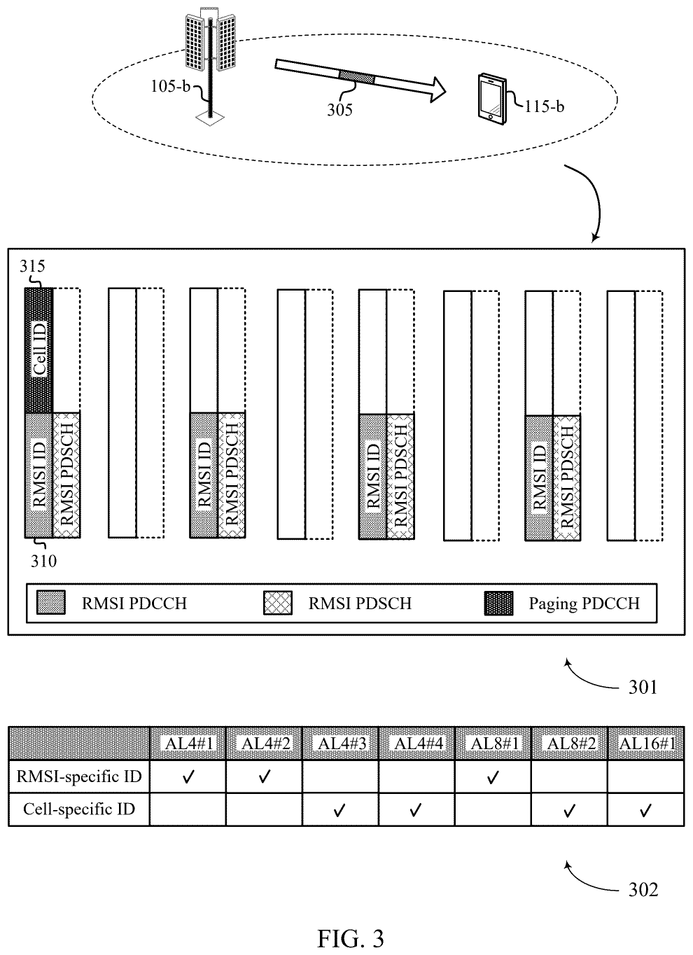

FIG. 3 shows an example of RMSI PDCCH-specific DMRS scrambling identifier implementations 301 and 302 that support DMRS distinction to support downlink channel combining in accordance with one or more aspects of the present disclosure. For example, the RMSI PDCCH-specific DMRS scrambling identifier implementations 301 and 302 may support communications between a network entity 105-b, and a UE 115-b, each of which may be examples of network entities 105 and UEs 115 described herein with reference to FIGS. 1 and 2.

RMSI PDCCH-specific DMRS scrambling identifier implementation 301 illustrates an example scheduling duration for receiving PSCCH and associated PDSCH scheduled for the UE 115-a. For example, the UE 115-b may receive one or more repetitions of an RMSI PDCCH that schedules an RMSI PDSCH, along with other PDCCH transmissions, such as one or more paging PDCCHs. In some aspects, the network entity may transmit one or more messages 305 that include an indication of an assignment of an RMSI PDCCH-specific DMRS scrambling identifier 310, so that the UE 115-b may distinguish the RMSI PDCCH from other types of PDCCHs (e.g., such as a paging PDCCH including a cell identifier 315 that is different or distinct from the RMSI PDCCH-specific DMRS scrambling identifier 310). The UE 115-b may identify the RMSI PDCCH using the RMSI PDCCH-specific DMRS scrambling identifier 310, and may accurately combine the RMSI PDCCHs for decoding.

In some examples, the UE 115-b may distinguish the RMSI PDCCH from other types of PDCCHs by measuring the correlation between the received DMRS and the RMSI PDCCH-specific DMRS sequence. For example, if a PDCCH candidate has a correlation that satisfies a threshold correlation, the UE 115-b may determine that the PDCCH candidate is an RMSI PDCCH candidate. Additionally, or alternatively, various types of PDCCHs that share CORESET0 may also share the same cell-specific DMRS scrambling ID, (e.g., pdcch-DMRS-ScramblingID=PCI), so the UE 115-b may determine which PDCCH candidates to combine among the detected (but not yet decoded) PDCCH candidates at CORESET0 or search space 0.

In some cases, the UE 115-b may perform blind decoding for PDCCH, and may monitor multiple DMRS scrambling identifiers for each PDCCH candidate, (e.g., for RMSI PDCCH-specific DMRS scrambling identifiers and cell-specific DMRS scrambling identifiers) In some aspects, the network entity 105-b may reduce the PDCCH blind decoding complexity for the RMSI-PDCCH by assigning RMSI PDCCH-specific DMRS scrambling identifiers to a subset of RMSI PDCCH candidates. For example, RMSI PDCCH-specific DMRS scrambling identifier implementation 302 illustrates an example assignment of RMSI PDCCH-specific DMRS scrambling identifiers to a subset of RMSI PDCCH candidates.

The UE 115-b may use a common search space to monitor for the RMSI PDCCH, which may include a seven PDCCH candidates (or another quantity of PDCCH candidates), each having different aggregation levels (e.g., AL4 #1, AL4 #2, AL4 #3, AL4 #4, AL8 #1, AL8 #2, and AL16 #1). The network entity 105-b may assign RMSI PDCCH-specific DMRS scrambling identifiers to a subset of RMSI PDCCH candidates that are available for combination by the UE 115-a. For example, the RMSI PDCCH candidates associated with AL4 #1, AL4 #2, and AL8 #1 may be RMSI PDCCH candidates associated with limited coverage scenarios, and may be assigned RMSI PDCCH-specific DMRS scrambling identifiers. The RMSI PDCCH candidates associated with AL4 #3, AL4 #4, AL8 #2, and AL16 #1 may be assigned a cell-specific identifier, for example, based on the aggregation level for the PDCCH candidates satisfying a threshold. In some aspects, each RMSI PDCCH candidate may use one of the scrambling sequences (e.g., either the RMSI PDCCH-specific DMRS scrambling identifiers or the cell-specific identifier). In some other aspects, an RMSI PDCCH candidate may be assigned both scrambling identifiers (e.g., both the RMSI PDCCH-specific DMRS scrambling identifier and the cell-specific identifier) such that the sets of candidates with different scrambling identifiers may at least partially overlap.

In some other implementations, in order to combine the RMSI PDCCH, the UE 115-b may determine whether the RMSI PDCCH is combinable (e.g., whether the RMSI PDCCH has identical content within the 160-ms RMSI TTI), and may use the RMSI PDCCH-specific DMRS scrambling identifier to enable the UE 115-b to distinguish RMSI PDCCH candidates from other types of PDCCH candidates. In some implementations, the network entity 105-b may transmit an indication in the MIB (e.g., a 1-bit indication) that indicates whether the RMSI PDCCH has identical content within the 160-ms RMSI TTI. For example, the MIB may include a field or an indicator (e.g., identical-RMSIPDCCH) that can include the single bit indicator. If the field or indicator has a bit value of 1 (e.g., identical-RMSIPDCCH=1), then the RMSI PDCCH is combinable over the RMSI TTI, and if the field or indicator has a bit value of 0 (e.g., identical-RMSIPDCCH=0), then the RMSI PDCCH is not combinable over the RMSI TTI. The identical-RMSIPDCCH may be included with other information in the MIB, including system frame number information, common subcarrier spacing information, SSB subcarrier offset information, DMRS type and position information, SIB1 PDCCH configuration information, barred cell information, intra frequency reselection information, among other information.

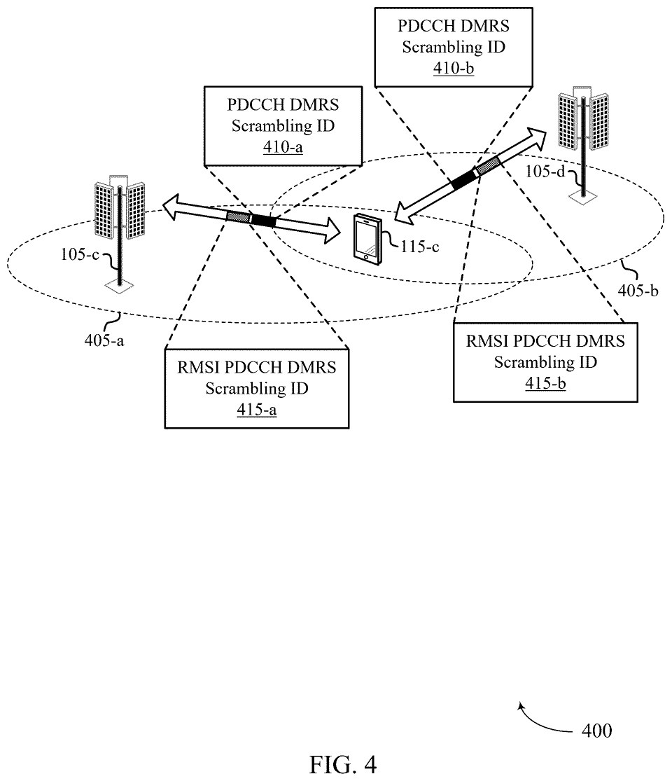

FIG. 4 shows an example of a wireless communications system 400 that supports DMRS distinction to support downlink channel combining in accordance with one or more aspects of the present disclosure. For example, the wireless communications system 400 illustrates communications between a network entity 105-c, and a UE 115-c operating in a first cell 405-a, and communications between a network entity 105-d and the UE 115-c operating in a second cell 405-b. The network entity 105-c, the network entity 105-d, and the UE 115-c each may be examples of network entities 105 and UEs 115 described herein with reference to FIGS. 1-3.

In some implementations, the UE 115-c may identify or obtain an indication of multiple RMSI PDCCH-specific DMRS scrambling identifiers for communication with multiple cells. For example, in some cases, the UE 115-c may receive an explicit indication of a first RMSI PDCCH-specific DMRS scrambling identifier 415-a, or the UE 115-c may implicitly determine or identify the first RMSI PDCCH-specific DMRS scrambling identifier 415-a based on a predefined rule (e.g., without an explicit indication). Additionally, the UE 115-c may receive an explicit indication of a second RMSI PDCCH-specific DMRS scrambling identifier 415-b, or the UE 115-c may implicitly determine or identify the second RMSI PDCCH-specific DMRS scrambling identifier 415-b based on a predefined rule (e.g., without an explicit indication). In some aspects, the predefined rule may reduce or eliminate the likelihood of collision between the first RMSI PDCCH-specific DMRS scrambling identifier 415-a (associated with the first cell 405-a) and a cell-specific DMRS scrambling identifier 410-b (associated with the second cell 405-b). The predefined rule may additionally or alternatively reduce or eliminate the likelihood of collision between the second RMSI PDCCH-specific DMRS scrambling identifier 415-b (associated with the second cell 405-b) and a cell-specific DMRS scrambling identifier 410-a (associated with the first cell 405-a).

For example, a PDCCH associated with CORESET0 may be assigned a cell-specific scrambling identifiers with values ranging from 0 to 1007 (e.g., pdcch-DMRS-ScramblingID=PCI∈{0, . . . , 1007}). To prevent the collision between the first RMSI PDCCH-specific DMRS scrambling identifier 415-a at the first cell 405-a and cell-specific DMRS scrambling identifier 410-b at the second cell 405-b, one example rule may include setting the first RMSI PDCCH-specific DMRS scrambling identifier 415-a to be equal to the PCI plus 1008 (e.g., RMSI-pdcch-DMRS-ScramblingID=PCI+1008) which allows the value for the first RMSI PDCCH-specific DMRS scrambling identifier 415-a to be greater than any cell-specific DMRS scrambling identifier ∈{0, . . . , 1007}, since the cell-specific DMRS scrambling IDs range ends at 1007, while the start of the range of the first RMSI PDCCH-specific DMRS scrambling identifier 415-a may be 1008.

In the aforementioned example, the cell-specific DMRS scrambling identifier 410-a for the first cell 405-a may be equal to the PCI (e.g., pdcch-DMRS-ScramblingID=PCI=0), and the first RMSI PDCCH-specific DMRS scrambling identifier 415-a for the first cell 405-a may be equal to the PCI plus 1008 (e.g., RMSI-pdcch-DMRS-ScramblingID=PCI+1008=1008). Then, the cell-specific DMRS scrambling identifier 410-b for the second cell 405-b may be equal to the PCI (e.g., pdcch-DMRS-ScramblingID=PCI=1007), and the second RMSI PDCCH-specific DMRS scrambling identifier 415-b for the second cell 405-b may be equal to the PCI plus 1008 (e.g., RMSI-pdcch-DMRS-ScramblingID=PCI+1008=2015).

In some other examples, to prevent the collision of RMSI PDCCH-specific DMRS scrambling identifiers and UE-specific DMRS scrambling identifiers associated with the first cell 405-a and the second cell 405-b, the RMSI PDCCH-specific DMRS scrambling identifiers occupied by the neighboring cells may be excluded from the UE-specific DMRS scrambling identifier assignments. In such examples, the network entity 105-c and the network entity 105-d may identify one or more RMSI PDCCH-specific DMRS identifiers occupied by neighboring cells, and may exclude the neighboring cell RMSI PDCCH-specific DMRS identifiers from the UE-specific DMRS scrambling identifier assignments. In some aspects, the network entity 105-c and the network entity 105-d may identify the RMSI PDCCH-specific DMRS identifiers based on implementation (e.g., gNB implementation), based on a UE-assisted procedure (e.g., the UE 115-c may transmit a neighboring cell measurement report), based on inter-network entity communications (e.g., through a backhaul link between the network entity 105-c and the network entity 105-d), or any combination thereof.

In such examples, the cell-specific DMRS scrambling identifier 410-a for the first cell 405-a may be equal to the PCI (e.g., pdcch-DMRS-ScramblingID=PCI=0), and the first RMSI PDCCH-specific DMRS scrambling identifier 415-a for the first cell 405-a may be equal to the PCI plus 1008 (e.g., RMSI-pdcch-DMRS-ScramblingID=PCI+1008=1008). The network entity 105-c may then exclude the PCI+1008=1009 from the UE-specific DMRS scrambling identifier assignment (to avoid collision with the second cell 405-b, which is a neighboring cell. Then, the cell-specific DMRS scrambling identifier 410-b for the second cell 405-b may be equal to the PCI (e.g., pdcch-DMRS-ScramblingID=PCI=1), and the second RMSI PDCCH-specific DMRS scrambling identifier 415-b for the second cell 405-b may be equal to the PCI plus 1008 (e.g., RMSI-pdcch-DMRS-ScramblingID=PCI+1008=1009).

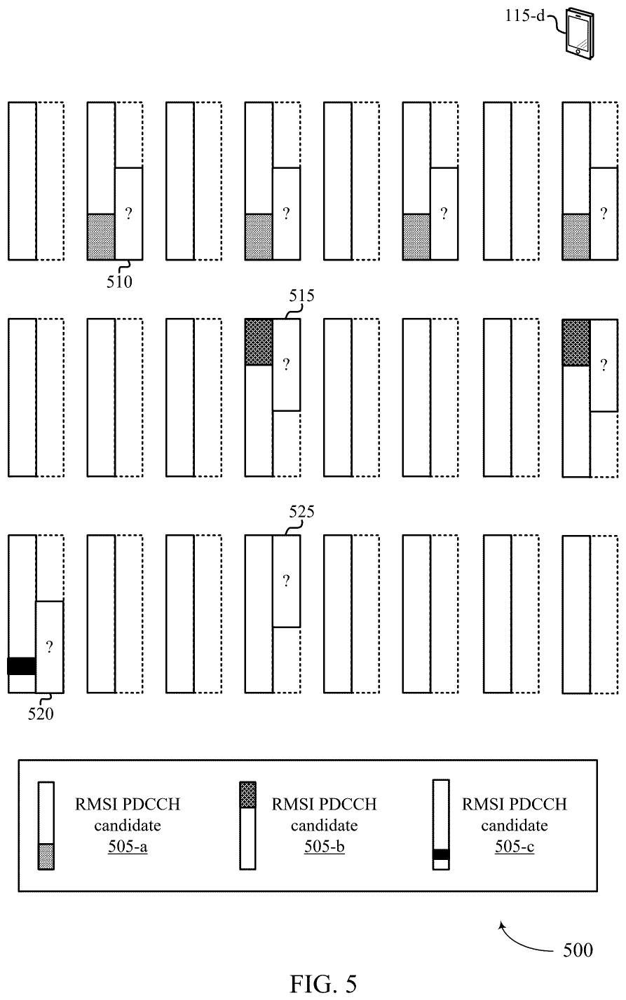

FIG. 5 shows an example of an RMSI PDCCH detection configuration 500 that supports DMRS distinction to support downlink channel combining in accordance with one or more aspects of the present disclosure. For example, the RMSI PDCCH detection configuration 500 may be implemented at or by a network entity 105, or a UE 115-d, which may be examples of corresponding devices described herein with reference to FIGS. 1-4.

The UE 115-d may monitor a search space for one or more RMSI PDCCH candidates. For example, the UE 115-d may monitor a search space for a set of repetitions of a first RMSI PDCCH candidate 505-a, a set of repetitions of a second RMSI PDCCH candidate 505-b, and for a third RMSI PDCCH candidate 505-c. In some aspects, if the UE 115-d detects (but does not decode) an RMSI PDCCH candidate, the UE 115-d may buffer the frequency domain I/Q samples where the RMSI PDCCH may potentially schedule the RMSI PDSCH, which may facilitate RMSI PDSCH combining. When the UE 115-d combines and decodes the RMSI PDCCH, the UE 115-d may then obtain the scheduling information of the RMSI PDCCH (e.g., FDRA/TDRA, VRB-to-PRB mapping, among other information) of the RMSI PDSCH. The UE 115-d may then determine a scheduled location of the RMSI PDSCH within the buffered FD I/Q samples, from which the RMSI PDSCH is extracted and combined. In some cases, however, buffering the entire range (e.g., symbol and resource block range), where the RMSI PDCCH can potentially schedule the RMSI PDSCH cause excess energy and memory expenditure for the UE 115-d.

In order to identify the buffering range more efficiently for the RMSI PDSCH combining, the UE 115-d may implement coarse scheduling information of the RMSI PDSCH with the RMSI PDCCH candidate indices. For example, each RMSI PDCCH candidate may be associated with a subset of frequency domain I/Q samples where the RMSI PDSCH may be scheduled (e.g., the first RMSI PDCCH candidate 505-a may be associated with a first set of frequency domain I/Q samples 510, the second RMSI PDCCH candidate 505-b may be associated with a first set of frequency domain I/Q samples 515, and third RMSI PDCCH candidate 505-c may be associated with a third set of frequency domain I/Q samples 520 and 525.

In some examples, an RMSI PDCCH candidate may indicate (e.g., point towards) a section of the initial BWP that the PDSCH is scheduled in. For example, the first RMSI PDCCH candidate 505-a may point towards the lower half of the initial BWP, so the UE 115-d may buffer the frequency domain I/Q samples of the lower half of the initial BWP. In some other examples, the second RMSI PDCCH candidate 505-b may point towards the upper half of the initial BWP, so the UE 115-d may buffer the frequency domain I/Q samples of the lower half of the initial BWP. In some other examples, the third RMSI PDCCH candidate 505-c may point towards the lower half of the initial BWP and an upper half of the initial BWP for different RMSI PDCCH indices, so the UE 115-d may buffer the frequency domain I/Q samples of the lower half and the upper half of the initial BWP. In such examples, the coarse scheduling of the RMSI PDCCH candidate may allow the UE 115-d to reduce a buffering load by one half, which may increase the available memory of the UE 115-d, and reduce power expenditure.

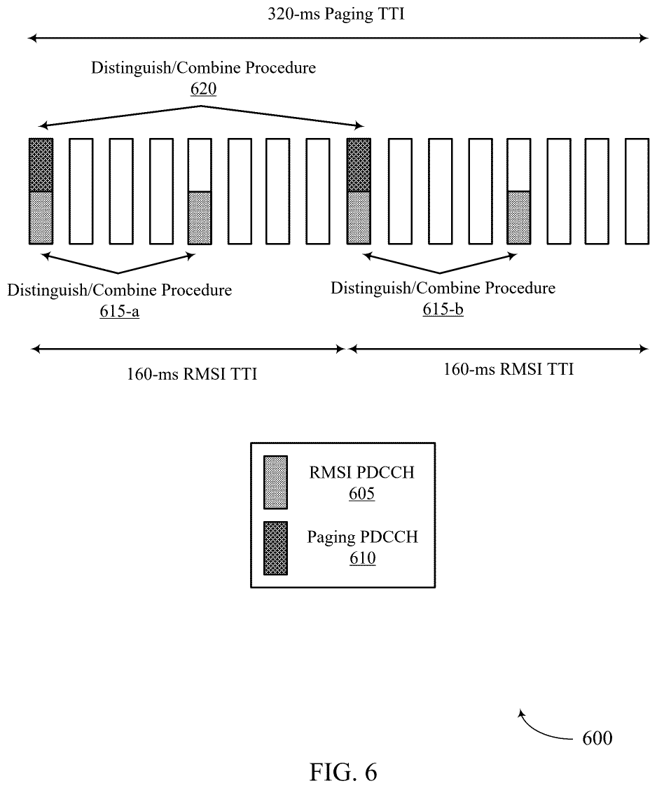

FIG. 6 shows an example of an RMSI PDCCH detection configuration 600 that supports DMRS distinction to support downlink channel combining in accordance with one or more aspects of the present disclosure. For example, the RMSI PDCCH detection configuration 600 may be implemented at or by a UE 115 or a network entity 105 described herein.

In some implementations, the RMSI PDCCH and various other types of PDCCHs (e.g., paging PDCCH, message 2 PDCCH, message 4 PDCCH, other system information PDCCH) may share the same DCI format (e.g., DCI format 1_0). In addition, the RMSI PDCCH may also share the same search space with the various other types of PDCCHs (e.g., RMSI PDCCH and paging PDCCH may share CORESET0 and search space 0). In some aspects, channel-specific DMRS scrambling IDs may be assigned to both the RMSI PDCCH and also to the other types of PDCCHs that share the same CORESET and search spaces. In such aspects, the UE may distinguish and combine each type of PDCCH via channel-specific DMRS detection.

A UE may monitor a search space over different TTI durations (e.g., a 320-ms paging TTI duration and 160 ms RMSI TTI duration) to detect different PDCCH. For example, the UE may monitor the 320-ms paging TTI duration for detection of at least one paging PDCCH 610, and may monitor the 160-ms RMSI TTI durations for detection of at least one RMSI PDCCH 605. In some aspects, a network entity may assign channel-specific DMRS scrambling IDs to various different types of PDCCHs (e.g., the paging PDCCH 610 and the RMSI PDCCH 605) that share the same CORESET, search space, or both, so that the UE can distinguish and combine each type of PDCCH via channel-specific DMRS detection.

For example, the RMSI PDCCH 605 and the paging PDCCH 610 may share CORESET0 and search space 0. The RMSI DCCH content may be identical during the 160-ms RMSI TTI, and the RMSI PDCCH-specific DMRS scrambling identifier may be equal to PCI+1008=1008. The paging PDCCH content may also be identical during the 320-ms RMSI TTI, and the paging PDCCH-specific DMRS scrambling identifier may be equal to PCI+1009=1009. The UE may then distinguish and combine the RMSI PDCCH 605 and paging PDCCH 610 separately via channel-specific DMRS detection.

The UE may use the DMRS scrambling identifier associated with the RMSI PDCCH-specific DMRS scrambling identifier (e.g., 1008) to distinguish and combine the RMSI PDCCH 605 every 160-ms RMSI TTI (e.g., via the distinguish and combine procedure 615-a and the distinguish and combine procedure 615-b). Additionally, or alternatively, the UE may use the DMRS scrambling identifier associated with the paging PDCCH-specific DMRS scrambling identifier (e.g., 1009) to distinguish and combine the paging PDCCH 610 every 320-ms paging TTI (e.g., via the distinguish and combine procedure 620).

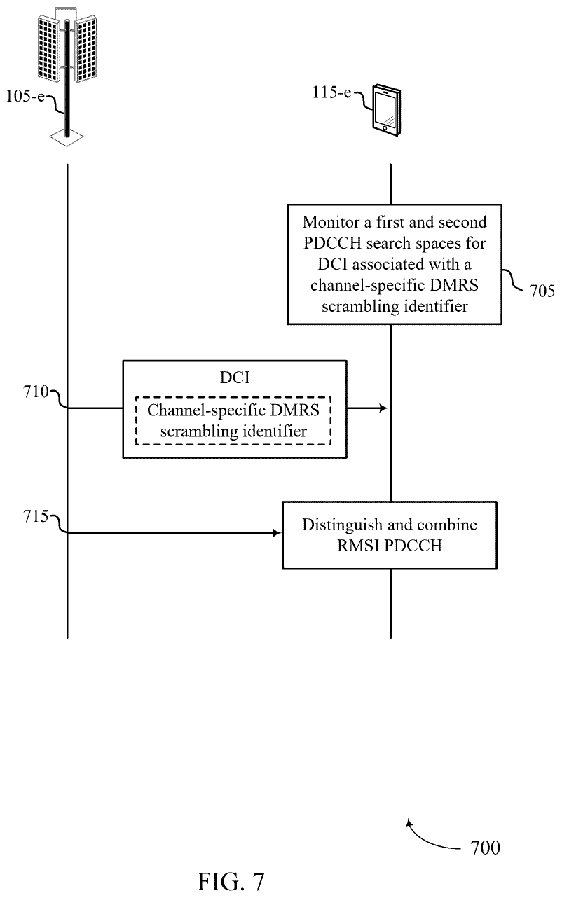

FIG. 7 shows an example of a process flow 700 that supports DMRS distinction to support downlink channel combining in accordance with one or more aspects of the present disclosure. For example, the process flow 700 illustrates communications between a UE 115-e (which may be an example a UE 115 described herein) and a network entity 105-e (which may be an example of a network entity 105 described herein).

Alternative examples of the following may be implemented. Some steps are performed in a different order than described herein or are not performed at all. In some implementations, steps may include additional features not mentioned below, or additional steps may be added. Further, although the UE 115-e and the network entity 105-e are shown performing the operations of the process flow 700, some aspects of some operations may also be performed by one or more other wireless communication devices.

At 705, the UE 115-e may monitor a first PDCCH search space and a second PDCCH search space for DCI associated with a channel-specific DMRS scrambling identifier. In some examples, the UE 115-e may monitor the first PDCCH search space and the second PDCCH search space for RMSI, and the channel-specific DMRS scrambling identifier indicates that the first PDCCH search space and the second PDCCH search space are associated with receiving the RMSI.

In some aspects, the channel-specific DMRS scrambling identifier is a first type of DMRS scrambling identifier that indicates RMSI-specific PDCCH. The UE 115-e may then monitor a third PDCCH search space for DCI associated with a second type of DMRS scrambling identifier that is different from the first type of DMRS scrambling identifier. In some examples, the second type of DMRS scrambling identifier indicates one or more PDCCHs that are different from the RMSI-specific PDCCH.

In some examples, the UE 115-e may determine that the channel-specific DMRS scrambling identifier indicates RMSI-specific PDCCH in accordance with a correlation between a received DMRS signal sequence and a DMRS sequence associated with the channel-specific DMRS scrambling identifier exceeding a correlation threshold.

In some examples, the channel-specific DMRS scrambling identifier may include an RMSI PDCCH-specific DMRS scrambling identifier associated with a first cell, and the UE 115-e may monitor a third PDCCH search space for DCI associated with a cell-specific DMRS scrambling identifier associated with a second cell. In such examples, the RMSI PDCCH-specific DMRS scrambling identifier may be different in value from the cell-specific DMRS scrambling identifier. In addition, in some cases, the RMSI PDCCH-specific DMRS scrambling identifier may be selected from a first set of identifier values, and the cell-specific DMRS scrambling identifier is selected from a second set of identifier values such that the first set of identifier values and the second set of identifier values are non-overlapping.

In some examples, the channel-specific DMRS scrambling identifier is associated with a first cell of the UE 115-e, and is selected from a set of channel-specific DMRS scrambling identifiers that excludes one or more channel-specific DMRS scrambling identifiers associated with one or more neighboring cells of the first cell. In some such examples, the UE 115-e may transmit a cell measurement report including one or more measurements for the first cell and the one or more neighboring cells of the first cell, and may receive an indication of the channel-specific DMRS scrambling identifier associated with the first cell (e.g., based on the measurement report). In some other examples, the network entity 105-e may determine the channel-specific DMRS scrambling identifier based on implementation, or based on backhaul signaling between a different network entity associated with the one or more neighboring cells.

In some examples, the channel-specific DMRS scrambling identifier is a first channel-specific DMRS scrambling identifier associated with the first PDCCH search space, and the UE 115-e may monitor the first PDCCH search space for DCI associated with the first channel-specific DMRS scrambling identifier and the second PDCCH search space for DCI associated with a second channel-specific DMRS scrambling identifier. In such examples, the first channel-specific DMRS scrambling identifier may be different from the second channel-specific DMRS scrambling identifier based on the first PDCCH search space and the second PDCCH search space being a same PDCCH search space, or based on the first PDCCH search space and the second PDCCH search space being associated with a same CORESET.

At 710, the UE 115-c may receive DCI associated with the channel-specific DMRS scrambling identifier according to the monitoring of the first PDCCH search space. In some examples, the UE 115-e may receive the DCI in accordance with a combination of a first DCI candidate of the first PDCCH search space and a second DCI candidate of the second PDCCH search space. In some examples, the first DCI candidate and the second DCI candidate may include a subset of DCI candidates of a quantity of DCI candidates associated with receiving RMSI, and the channel-specific DMRS scrambling identifier corresponds to the subset of DCI candidates. In such examples, the channel-specific DMRS scrambling identifier may correspond to the subset of DCI candidates based on the UE 115-e receiving the DCI in accordance with the combination of the subset of DCI candidates.

In some implementations, the UE 115-e may receive a MIB that includes at least one field that indicates (e.g., via a single bit indicator) whether first content of the first DCI candidate of the first PDCCH search space is identical to second content of the second DCI candidate of the second PDCCH search space.

In some cases, the UE 115-c may buffer, prior to combining and decoding the first DCI candidate and the second DCI candidate, one or more frequency domain I/Q samples that are candidates for the PDSCH scheduled by the first DCI candidate or the second DCI candidate. In some examples, the first DCI candidate, the second DCI candidate, or both, indicate a scheduling of the one or more frequency domain I/Q samples for the PDSCH that spans a portion of a downlink DWP.

At 715, the UE 115-e may receive one or more PDSCH transmissions in accordance with the DCI.

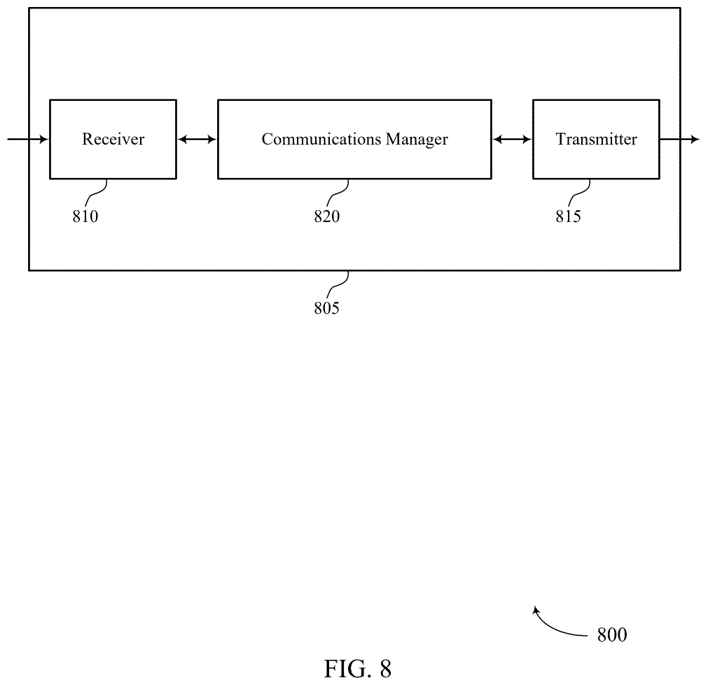

FIG. 8 shows a block diagram 800 of a device 805 that supports DMRS distinction to support downlink channel combining in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to DMRS distinction to support downlink channel combining). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to DMRS distinction to support downlink channel combining). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of DMRS distinction to support downlink channel combining as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described herein in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described herein in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for monitoring a first PDCCH search space and a second PDCCH search space for DCI associated with a channel-specific DMRS scrambling identifier. The communications manager 820 is capable of, configured to, or operable to support a means for receiving DCI associated with the channel-specific DMRS scrambling identifier according to the monitoring, where the DCI is received in accordance with a combination of a first DCI candidate of the first PDCCH search space and a second DCI candidate of the second PDCCH search space. The communications manager 820 is capable of, configured to, or operable to support a means for receiving an PDSCH transmission in accordance with the DCI.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, more efficient usage of memory resources, and more efficient communication of system information.

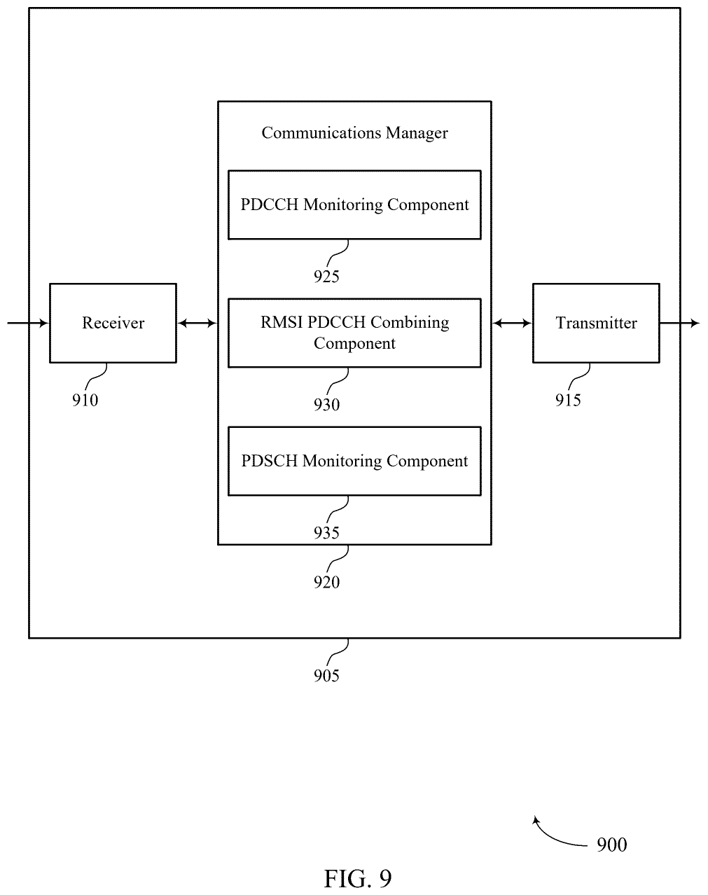

FIG. 9 shows a block diagram 900 of a device 905 that supports DMRS distinction to support downlink channel combining in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to DMRS distinction to support downlink channel combining). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to DMRS distinction to support downlink channel combining). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of DMRS distinction to support downlink channel combining as described herein. For example, the communications manager 920 may include a PDCCH monitoring component 925, an RMSI PDCCH combining component 930, an PDSCH monitoring component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The PDCCH monitoring component 925 is capable of, configured to, or operable to support a means for monitoring a first PDCCH search space and a second PDCCH search space for DCI associated with a channel-specific DMRS scrambling identifier. The RMSI PDCCH combining component 930 is capable of, configured to, or operable to support a means for receiving DCI associated with the channel-specific DMRS scrambling identifier according to the monitoring, where the DCI is received in accordance with a combination of a first DCI candidate of the first PDCCH search space and a second DCI candidate of the second PDCCH search space. The PDSCH monitoring component 935 is capable of, configured to, or operable to support a means for receiving an PDSCH transmission in accordance with the DCI.

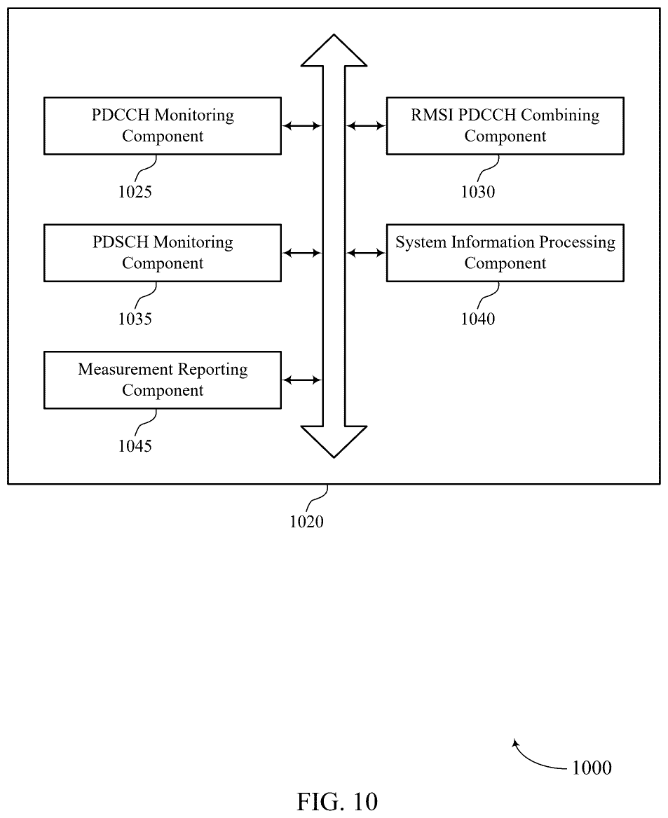

FIG. 10 shows a block diagram 1000 of a communications manager 1020 that supports DMRS distinction to support downlink channel combining in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of DMRS distinction to support downlink channel combining as described herein. For example, the communications manager 1020 may include a PDCCH monitoring component 1025, an RMSI PDCCH combining component 1030, an PDSCH monitoring component 1035, a system information processing component 1040, a measurement reporting component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The PDCCH monitoring component 1025 is capable of, configured to, or operable to support a means for monitoring a first PDCCH search space and a second PDCCH search space for DCI associated with a channel-specific DMRS scrambling identifier. The RMSI PDCCH combining component 1030 is capable of, configured to, or operable to support a means for receiving DCI associated with the channel-specific DMRS scrambling identifier according to the monitoring, where the DCI is received in accordance with a combination of a first DCI candidate of the first PDCCH search space and a second DCI candidate of the second PDCCH search space. The PDSCH monitoring component 1035 is capable of, configured to, or operable to support a means for receiving an PDSCH transmission in accordance with the DCI.

In some examples, to support monitoring the first PDCCH search space and the second PDCCH search space, the PDCCH monitoring component 1025 is capable of, configured to, or operable to support a means for monitoring the first PDCCH search space and the second PDCCH search space for RMSI, where the channel-specific DMRS scrambling identifier indicates that the first PDCCH search space and the second PDCCH search space are associated with receiving the RMSI.

In some examples, the channel-specific DMRS scrambling identifier includes a first type of DMRS scrambling identifier that indicates RMSI-specific PDCCH, and the PDCCH monitoring component 1025 is capable of, configured to, or operable to support a means for monitoring a third PDCCH search space for DCI associated with a second type of DMRS scrambling identifier that is different from the first type of DMRS scrambling identifier, where the second type of DMRS scrambling identifier indicates one or more PDCCHs that are different from the RMSI-specific PDCCH.

In some examples, the PDCCH monitoring component 1025 is capable of, configured to, or operable to support a means for determining that the channel-specific DMRS scrambling identifier indicates RMSI-specific PDCCH in accordance with a correlation between a received DMRS signal sequence and a DMRS sequence associated with the channel-specific DMRS scrambling identifier exceeding a correlation threshold.

In some examples, the first DCI candidate and the second DCI candidate include a subset of DCI candidates of a set of multiple DCI candidates associated with receiving RMSI, and the channel-specific DMRS scrambling identifier corresponds to the subset of DCI candidates. In some examples, the channel-specific DMRS scrambling identifier corresponds to the subset of DCI candidates based on the DCI being received in accordance with the combination of the subset of DCI candidates.

In some examples, the system information processing component 1040 is capable of, configured to, or operable to support a means for receiving a master information block including at least one field that indicates whether first content of the first DCI candidate of the first PDCCH search space is identical to second content of the second DCI candidate of the second PDCCH search space. In some examples, the at least one field of the master information block includes a single bit that indicates whether the first content is identical to the second content.

In some examples, the channel-specific DMRS scrambling identifier includes an RMSI PDCCH-specific DMRS scrambling identifier associated with a first cell, and the PDCCH monitoring component 1025 is capable of, configured to, or operable to support a means for monitoring a third PDCCH search space for DCI associated with a cell-specific DMRS scrambling identifier associated with a second cell, where the RMSI PDCCH-specific DMRS scrambling identifier is different in value from the cell-specific DMRS scrambling identifier.

In some examples, the RMSI PDCCH-specific DMRS scrambling identifier is selected from a first set of identifier values and the cell-specific DMRS scrambling identifier is selected from a second set of identifier values. In some examples, the first set of identifier values and the second set of identifier values are non-overlapping. In some examples, the channel-specific DMRS scrambling identifier is associated with a first cell of the UE, and is selected from a set of multiple channel-specific DMRS scrambling identifiers that excludes one or more channel-specific DMRS scrambling identifiers associated with one or more neighboring cells of the first cell.

In some examples, the measurement reporting component 1045 is capable of, configured to, or operable to support a means for transmitting a cell measurement report including one or more measurements for the first cell and the one or more neighboring cells of the first cell. In some examples, the PDCCH monitoring component 1025 is capable of, configured to, or operable to support a means for receiving, in accordance with the cell measurement report, an indication of the channel-specific DMRS scrambling identifier associated with the first cell.

In some examples, the PDCCH monitoring component 1025 is capable of, configured to, or operable to support a means for buffering, prior to combining and decoding the first DCI candidate and the second DCI candidate, one or more frequency domain in-phase/quadrature (I/Q) samples that are candidates for the PDSCH scheduled by the first DCI candidate or the second DCI candidate. In some examples, the first DCI candidate, the second DCI candidate, or both, indicate a scheduling of the one or more frequency domain I/Q samples for the PDSCH that spans a portion of a downlink bandwidth part.

In some examples, the channel-specific DMRS scrambling identifier includes a first channel-specific DMRS scrambling identifier associated with the first PDCCH search space and, to support monitoring the first PDCCH search space and the second PDCCH search space, the PDCCH monitoring component 1025 is capable of, configured to, or operable to support a means for monitoring the first PDCCH search space for DCI associated with the first channel-specific DMRS scrambling identifier and the second PDCCH search space for DCI associated with a second channel-specific DMRS scrambling identifier, where the first channel-specific DMRS scrambling identifier is different from the second channel-specific DMRS scrambling identifier based on the first PDCCH search space and the second PDCCH search space including a same PDCCH search space.

In some examples, the channel-specific DMRS scrambling identifier includes a first channel-specific DMRS scrambling identifier associated with the first PDCCH search space and, to support monitoring the first PDCCH search space and the second PDCCH search space, the PDCCH monitoring component 1025 is capable of, configured to, or operable to support a means for monitoring the first PDCCH search space for DCI associated with the first channel-specific DMRS scrambling identifier and the second PDCCH search space for DCI associated with a second channel-specific DMRS scrambling identifier, where the first channel-specific DMRS scrambling identifier is different from the second channel-specific DMRS scrambling identifier based on the first PDCCH search space and the second PDCCH search space being associated with a same control resource set.

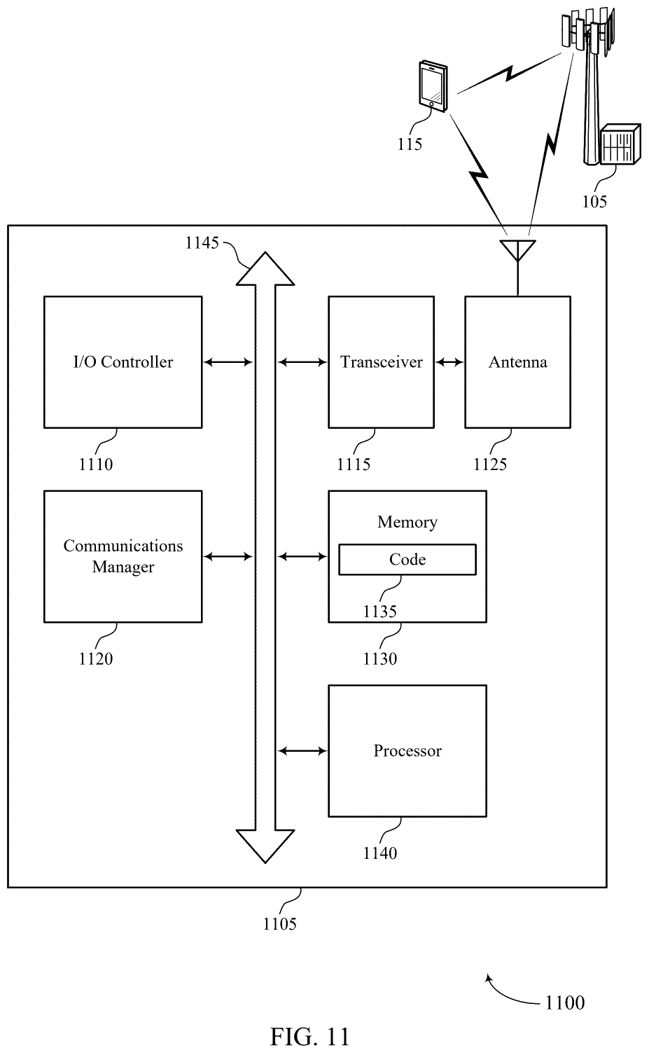

FIG. 11 shows a diagram of a system 1100 including a device 1105 that supports DMRS distinction to support downlink channel combining in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting DMRS distinction to support downlink channel combining). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for monitoring a first PDCCH search space and a second PDCCH search space for DCI associated with a channel-specific DMRS scrambling identifier. The communications manager 1120 is capable of, configured to, or operable to support a means for receiving DCI associated with the channel-specific DMRS scrambling identifier according to the monitoring, where the DCI is received in accordance with a combination of a first DCI candidate of the first PDCCH search space and a second DCI candidate of the second PDCCH search space. The communications manager 1120 is capable of, configured to, or operable to support a means for receiving an PDSCH transmission in accordance with the DCI.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, more efficient usage of memory resources, and more efficient communication of system information.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described herein with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of DMRS distinction to support downlink channel combining as described herein, or the at least one processor 1140 and the at least one memory 1130 may be otherwise configured to, individually or collectively, perform or support such operations.

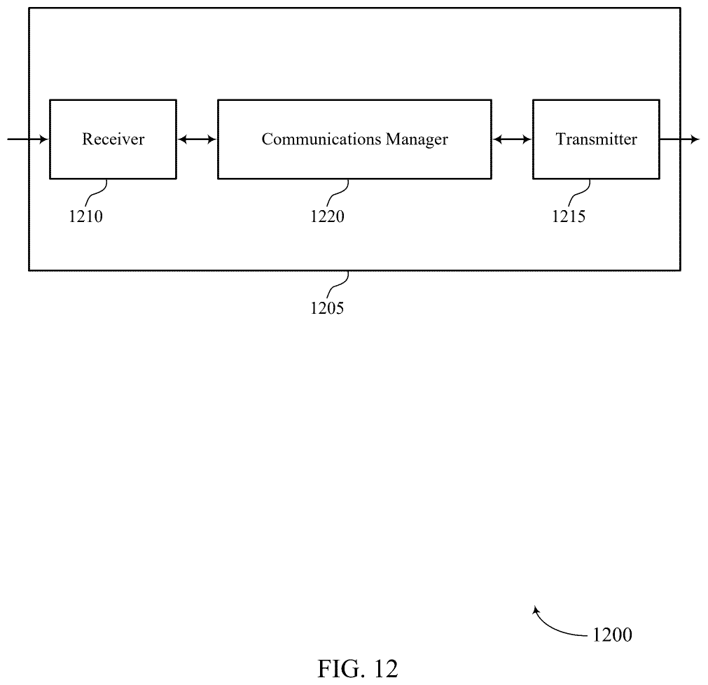

FIG. 12 shows a block diagram 1200 of a device 1205 that supports DMRS distinction to support downlink channel combining in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas (such as antenna 1125). Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas (such as antenna 1125). Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of DMRS distinction to support downlink channel combining as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry, not shown). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described herein in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described herein in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting, to a UE, DCI associated with a channel-specific DMRS scrambling identifier, where the DCI is output in accordance with a combination of a first DCI candidate of a first PDCCH search space and a second DCI candidate of a second PDCCH search space. The communications manager 1220 is capable of, configured to, or operable to support a means for outputting an PDSCH transmission in accordance with the DCI.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, more efficient utilization of communication resources, more efficient usage of memory resources, and more efficient communication of system information.

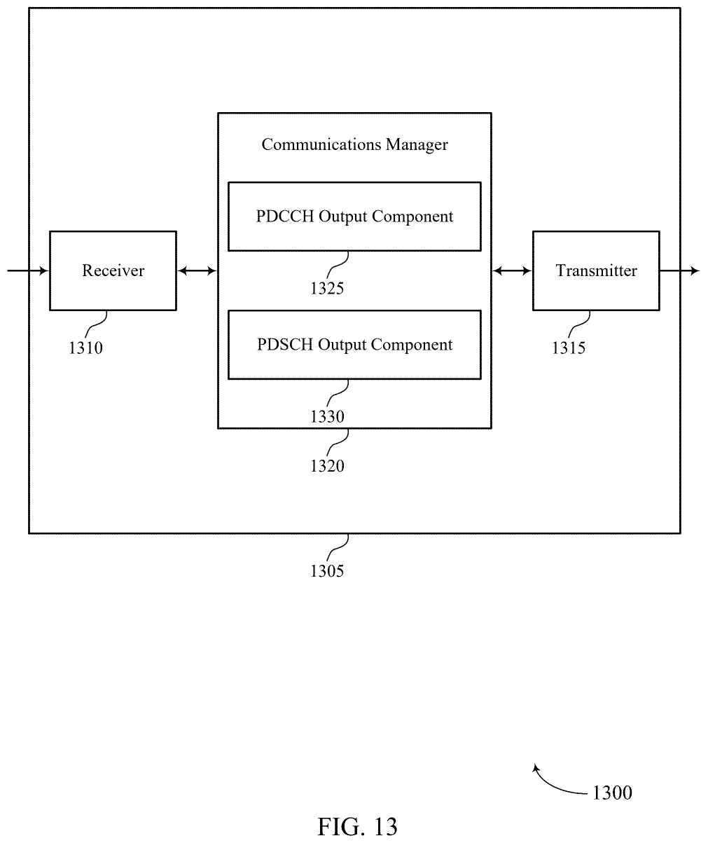

FIG. 13 shows a block diagram 1300 of a device 1305 that supports DMRS distinction to support downlink channel combining in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas (such as antenna 1125). Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of DMRS distinction to support downlink channel combining as described herein. For example, the communications manager 1320 may include a PDCCH output component 1325 an PDSCH output component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The PDCCH output component 1325 is capable of, configured to, or operable to support a means for outputting, to a UE, DCI associated with a channel-specific DMRS scrambling identifier, where the DCI is output in accordance with a combination of a first DCI candidate of a first PDCCH search space and a second DCI candidate of a second PDCCH search space. The PDSCH output component 1330 is capable of, configured to, or operable to support a means for outputting an PDSCH transmission in accordance with the DCI.

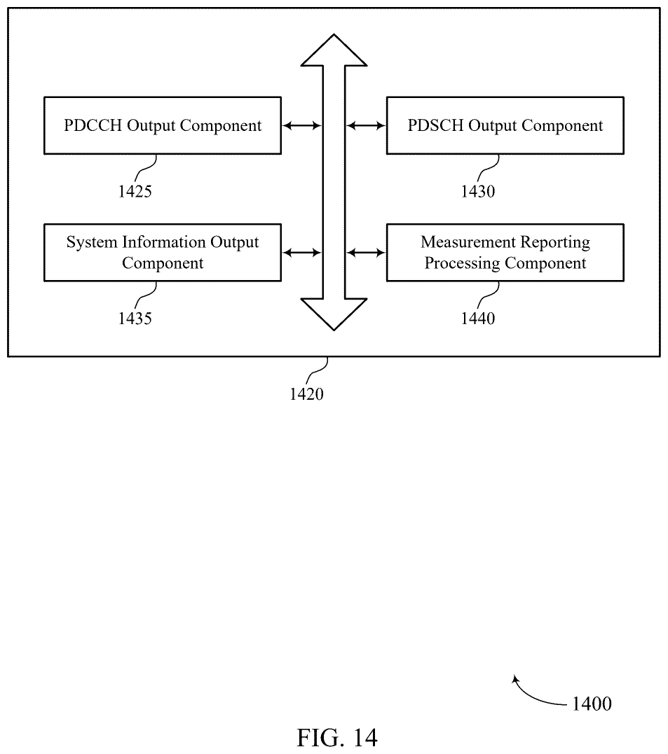

FIG. 14 shows a block diagram 1400 of a communications manager 1420 that supports DMRS distinction to support downlink channel combining in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of DMRS distinction to support downlink channel combining as described herein. For example, the communications manager 1420 may include a PDCCH output component 1425, an PDSCH output component 1430, a system information output component 1435, a measurement reporting processing component 1440, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The PDCCH output component 1425 is capable of, configured to, or operable to support a means for outputting, to a UE, DCI associated with a channel-specific DMRS scrambling identifier, where the DCI is output in accordance with a combination of a first DCI candidate of a first PDCCH search space and a second DCI candidate of a second PDCCH search space. The PDSCH output component 1430 is capable of, configured to, or operable to support a means for outputting an PDSCH transmission in accordance with the DCI.

In some examples, the channel-specific DMRS scrambling identifier indicates that the first PDCCH search space and the second PDCCH search space are associated with receiving RMSI. In some examples, the channel-specific DMRS scrambling identifier includes a first type of DMRS scrambling identifier that indicates RMSI-specific PDCCH, and the PDCCH output component 1425 is capable of, configured to, or operable to support a means for outputting DCI associated with a second type of DMRS scrambling identifier that is different from the first type of DMRS scrambling identifier, where the second type of DMRS scrambling identifier indicates one or more PDCCHs that are different from the RMSI-specific PDCCH.

In some examples, the first DCI candidate and the second DCI candidate include a subset of DCI candidates of a set of multiple DCI candidates associated with outputting RMSI, and the channel-specific DMRS scrambling identifier corresponds to the subset of DCI candidates. In some examples, the channel-specific DMRS scrambling identifier corresponds to the subset of DCI candidates based on the DCI being output in accordance with the combination of the subset of DCI candidates.

In some examples, the system information output component 1435 is capable of, configured to, or operable to support a means for outputting a master information block including at least one field that indicates whether first content of the first DCI candidate of the first PDCCH search space is identical to second content of the second DCI candidate of the second PDCCH search space, where the at least one field of the master information block includes a single bit that indicates whether the first content is identical to the second content.

In some examples, the channel-specific DMRS scrambling identifier includes an RMSI PDCCH-specific DMRS scrambling identifier associated with a first cell. In some examples, the RMSI PDCCH-specific DMRS scrambling identifier is different in value from a cell-specific DMRS scrambling identifier associated with a second cell.

In some examples, the channel-specific DMRS scrambling identifier is associated with a first cell associated with the network entity, and the PDCCH output component 1425 is capable of, configured to, or operable to support a means for selecting the channel-specific DMRS scrambling identifier from a set of multiple channel-specific DMRS scrambling identifiers that excludes one or more channel-specific DMRS scrambling identifiers associated with one or more neighboring cells of the first cell.

In some examples, the measurement reporting processing component 1440 is capable of, configured to, or operable to support a means for obtaining a cell measurement report including one or more measurements for the first cell and the one or more neighboring cells of the first cell. In some examples, the PDCCH output component 1425 is capable of, configured to, or operable to support a means for outputting, in accordance with the cell measurement report, an indication of the channel-specific DMRS scrambling identifier associated with the first cell.

In some examples, the PDCCH output component 1425 is capable of, configured to, or operable to support a means for obtaining an indication of the channel-specific DMRS scrambling identifier via one or more backhaul links associated with the network entity. In some examples, the DCI indicates a scheduling of one or more frequency domain I/Q samples for the PDSCH that spans a portion of a downlink bandwidth part.

In some examples, the channel-specific DMRS scrambling identifier includes a first channel-specific DMRS scrambling identifier associated with the first PDCCH search space. In some examples, the first channel-specific DMRS scrambling identifier is different from the second channel-specific DMRS scrambling identifier based on the first PDCCH search space and the second PDCCH search space including a same PDCCH search space, or based on the first PDCCH search space and the second PDCCH search space being associated with a same control resource set.

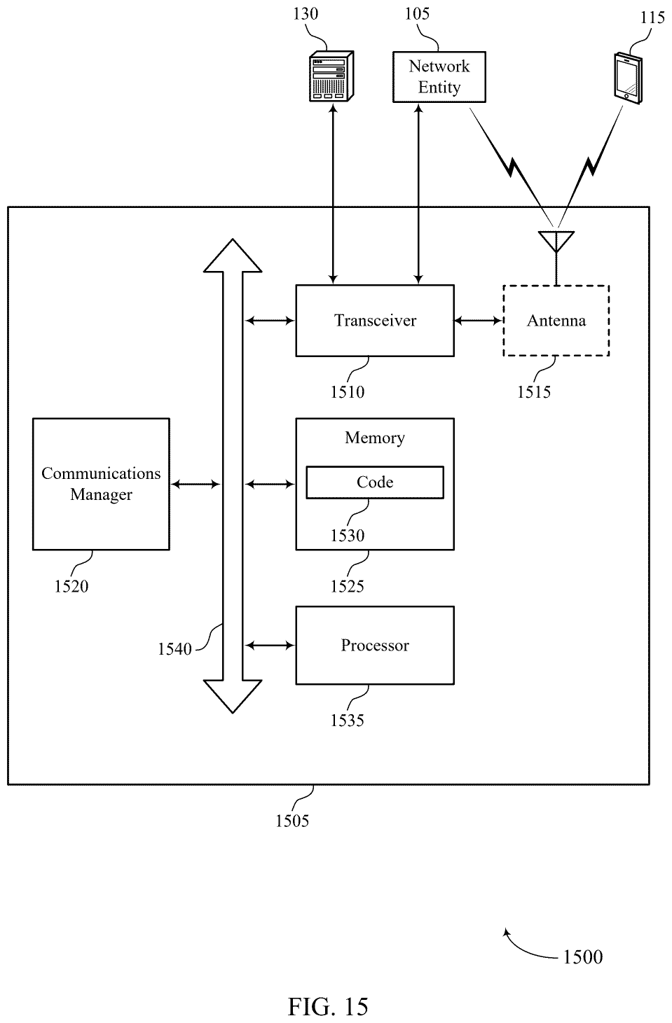

FIG. 15 shows a diagram of a system 1500 including a device 1505 that supports DMRS distinction to support downlink channel combining in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting DMRS distinction to support downlink channel combining). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting, to a UE, DCI associated with a channel-specific DMRS scrambling identifier, where the DCI is output in accordance with a combination of a first DCI candidate of a first PDCCH search space and a second DCI candidate of a second PDCCH search space. The communications manager 1520 is capable of, configured to, or operable to support a means for outputting an PDSCH transmission in accordance with the DCI.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, improved utilization of processing capability, more efficient usage of memory resources, and more efficient communication of system information.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described herein with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of DMRS distinction to support downlink channel combining as described herein, or the at least one processor 1535 and the at least one memory 1525 may be otherwise configured to, individually or collectively, perform or support such operations.

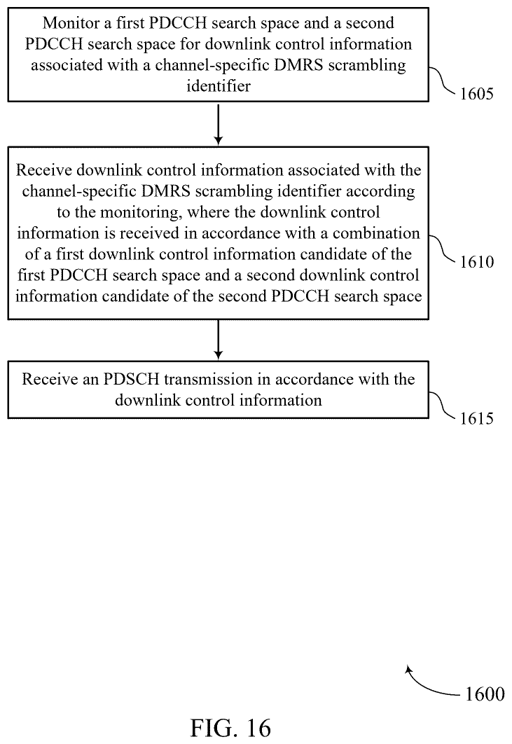

FIG. 16 shows a flowchart illustrating a method 1600 that supports demodulation reference signal distinction to support downlink channel combining in accordance with one or more aspects of the present disclosure. The operations of the method 1600 may be implemented by a UE or its components as described herein. For example, the operations of the method 1600 may be performed by a UE 115 as described herein with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include monitoring a first PDCCH search space and a second PDCCH search space for downlink control information associated with a channel-specific DMRS scrambling identifier. The operations of 1605 may be performed in accordance with examples as disclosed herein. In some examples, aspects of the operations of 1605 may be performed by a PDCCH monitoring component 1025 as described herein with reference to FIG. 10.

At 1610, the method may include receiving downlink control information associated with the channel-specific DMRS scrambling identifier according to the monitoring, where the downlink control information is received in accordance with a combination of a first downlink control information candidate of the first PDCCH search space and a second downlink control information candidate of the second PDCCH search space. The operations of 1610 may be performed in accordance with examples as disclosed herein. In some examples, aspects of the operations of 1610 may be performed by an RMSI PDCCH combining component 1030 as described herein with reference to FIG. 10.

At 1615, the method may include receiving an PDSCH transmission in accordance with the downlink control information. The operations of 1615 may be performed in accordance with examples as disclosed herein. In some examples, aspects of the operations of 1615 may be performed by an PDSCH monitoring component 1035 as described herein with reference to FIG. 10.

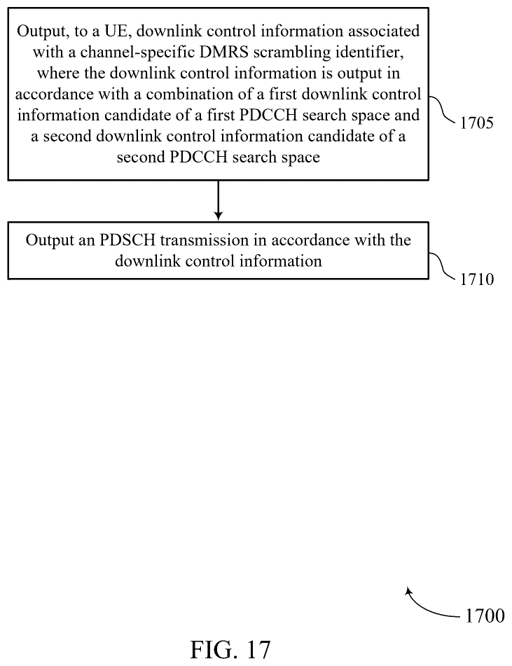

FIG. 17 shows a flowchart illustrating a method 1700 that supports demodulation reference signal distinction to support downlink channel combining in accordance with one or more aspects of the present disclosure. The operations of the method 1700 may be implemented by a network entity or its components as described herein. For example, the operations of the method 1700 may be performed by a network entity as described herein with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, downlink control information associated with a channel-specific DMRS scrambling identifier, where the downlink control information is output in accordance with a combination of a first downlink control information candidate of a first PDCCH search space and a second downlink control information candidate of a second PDCCH search space. The operations of 1705 may be performed in accordance with examples as disclosed herein. In some examples, aspects of the operations of 1705 may be performed by a PDCCH output component 1425 as described herein with reference to FIG. 14.

At 1710, the method may include outputting an PDSCH transmission in accordance with the downlink control information. The operations of 1710 may be performed in accordance with examples as disclosed herein. In some examples, aspects of the operations of 1710 may be performed by an PDSCH output component 1430 as described herein with reference to FIG. 14.

The following provides an overview of aspects of the present disclosure:
Aspect 1: A method for wireless communications at a UE, comprising: monitoring a first PDCCH search space and a second PDCCH search space for DCI associated with a channel-specific DMRS scrambling identifier; receiving DCI associated with the channel-specific DMRS scrambling identifier according to the monitoring, wherein the DCI is received in accordance with a combination of a first DCI candidate of the first PDCCH search space and a second DCI candidate of the second PDCCH search space; and receiving an PDSCH transmission in accordance with the DCI.
Aspect 2: The method of aspect 1, wherein monitoring the first PDCCH search space and the second PDCCH search space comprises: monitoring the first PDCCH search space and the second PDCCH search space for RMSI, wherein the channel-specific DMRS scrambling identifier indicates that the first PDCCH search space and the second PDCCH search space are associated with receiving the RMSI.
Aspect 3: The method of any of aspects 1 through 2, wherein the channel-specific DMRS scrambling identifier comprises a first type of DMRS scrambling identifier that indicates RMSI-specific PDCCH, the method further comprising: monitoring a third PDCCH search space for DCI associated with a second type of DMRS scrambling identifier that is different from the first type of DMRS scrambling identifier, wherein the second type of DMRS scrambling identifier indicates one or more PDCCHs that are different from the RMSI-specific PDCCH.
Aspect 4: The method of any of aspects 1 through 3, further comprising: determining that the channel-specific DMRS scrambling identifier indicates RMSI-specific PDCCH in accordance with a correlation between a received DMRS signal sequence and a DMRS sequence associated with the channel-specific DMRS scrambling identifier exceeding a correlation threshold.
Aspect 5: The method of any of aspects 1 through 4, wherein the first DCI candidate and the second DCI candidate comprise a subset of DCI candidates of a plurality of DCI candidates associated with receiving RMSI, and the channel-specific DMRS scrambling identifier corresponds to the subset of DCI candidates.
Aspect 6: The method of aspect 5, wherein the channel-specific DMRS scrambling identifier corresponds to the subset of DCI candidates based at least in part on the DCI being received in accordance with the combination of the subset of DCI candidates.
Aspect 7: The method of any of aspects 1 through 6, further comprising: receiving a MIB comprising at least one field that indicates whether first content of the first DCI candidate of the first PDCCH search space is identical to second content of the second DCI candidate of the second PDCCH search space.
Aspect 8: The method of aspect 7, wherein the at least one field of the MIB comprises a single bit that indicates whether the first content is identical to the second content.
Aspect 9: The method of any of aspects 1 through 8, wherein the channel-specific DMRS scrambling identifier comprises a RMSI PDCCH-specific DMRS scrambling identifier associated with a first cell, the method further comprising: monitoring a third PDCCH search space for DCI associated with a cell-specific DMRS scrambling identifier associated with a second cell, wherein the RMSI PDCCH-specific DMRS scrambling identifier is different in value from the cell-specific DMRS scrambling identifier.
Aspect 10: The method of aspect 9, wherein the RMSI PDCCH-specific DMRS scrambling identifier is selected from a first set of identifier values and the cell-specific DMRS scrambling identifier is selected from a second set of identifier values, the first set of identifier values and the second set of identifier values are non-overlapping.
Aspect 11: The method of any of aspects 1 through 10, wherein the channel-specific DMRS scrambling identifier is associated with a first cell of the UE, and is selected from a plurality of channel-specific DMRS scrambling identifiers that excludes one or more channel-specific DMRS scrambling identifiers associated with one or more neighboring cells of the first cell.
Aspect 12: The method of aspect 11, further comprising: transmitting a cell measurement report including one or more measurements for the first cell and the one or more neighboring cells of the first cell; and receiving, in accordance with the cell measurement report, an indication of the channel-specific DMRS scrambling identifier associated with the first cell.
Aspect 13: The method of any of aspects 1 through 12, further comprising: buffering, prior to combining and decoding the first DCI candidate and the second DCI candidate, one or more frequency domain I/Q samples that are candidates for the PDSCH scheduled by the first DCI candidate or the second DCI candidate.
Aspect 14: The method of aspect 13, wherein the first DCI candidate, the second DCI candidate, or both, indicate a scheduling of the one or more frequency domain I/Q samples for the PDSCH that spans a portion of a downlink bandwidth part.
Aspect 15: The method of any of aspects 1 through 14, wherein the channel-specific DMRS scrambling identifier comprises a first channel-specific DMRS scrambling identifier associated with the first PDCCH search space, and monitoring the first PDCCH search space and the second PDCCH search space comprises: monitoring the first PDCCH search space for DCI associated with the first channel-specific DMRS scrambling identifier and the second PDCCH search space for DCI associated with a second channel-specific DMRS scrambling identifier, wherein the first channel-specific DMRS scrambling identifier is different from the second channel-specific DMRS scrambling identifier based at least in part on the first PDCCH search space and the second PDCCH search space comprising a same PDCCH search space.
Aspect 16: The method of any of aspects 1 through 15, wherein the channel-specific DMRS scrambling identifier comprises a first channel-specific DMRS scrambling identifier associated with the first PDCCH search space, and monitoring the first PDCCH search space and the second PDCCH search space comprises: monitoring the first PDCCH search space for DCI associated with the first channel-specific DMRS scrambling identifier and the second PDCCH search space for DCI associated with a second channel-specific DMRS scrambling identifier, wherein the first channel-specific DMRS scrambling identifier is different from the second channel-specific DMRS scrambling identifier based at least in part on the first PDCCH search space and the second PDCCH search space being associated with a same control resource set.
Aspect 17: A method for wireless communications at a network entity, comprising: outputting, to a UE, DCI associated with a channel-specific DMRS scrambling identifier, wherein the DCI is output in accordance with a combination of a first DCI candidate of a first PDCCH search space and a second DCI candidate of a second PDCCH search space; and outputting an PDSCH transmission in accordance with the DCI.
Aspect 18: The method of aspect 17, wherein the channel-specific DMRS scrambling identifier indicates that the first PDCCH search space and the second PDCCH search space are associated with receiving RMSI.
Aspect 19: The method of any of aspects 17 through 18, wherein the channel-specific DMRS scrambling identifier comprises a first type of DMRS scrambling identifier that indicates RMSI-specific PDCCH, the method further comprising: outputting DCI associated with a second type of DMRS scrambling identifier that is different from the first type of DMRS scrambling identifier, wherein the second type of DMRS scrambling identifier indicates one or more PDCCHs that are different from the RMSI-specific PDCCH.
Aspect 20: The method of any of aspects 17 through 19, wherein the first DCI candidate and the second DCI candidate comprise a subset of DCI candidates of a plurality of DCI candidates associated with outputting RMSI, and the channel-specific DMRS scrambling identifier corresponds to the subset of DCI candidates.
Aspect 21: The method of aspect 20, wherein the channel-specific DMRS scrambling identifier corresponds to the subset of DCI candidates based at least in part on the DCI being output in accordance with the combination of the subset of DCI candidates.
Aspect 22: The method of any of aspects 17 through 21, further comprising: outputting a MIB comprising at least one field that indicates whether first content of the first DCI candidate of the first PDCCH search space is identical to second content of the second DCI candidate of the second PDCCH search space, wherein the at least one field of the MIB comprises a single bit that indicates whether the first content is identical to the second content.
Aspect 23: The method of any of aspects 17 through 22, wherein the channel-specific DMRS scrambling identifier comprises a RMSI PDCCH-specific DMRS scrambling identifier associated with a first cell, the RMSI PDCCH-specific DMRS scrambling identifier is different in value from a cell-specific DMRS scrambling identifier associated with a second cell.
Aspect 24: The method of any of aspects 17 through 23, wherein the channel-specific DMRS scrambling identifier is associated with a first cell associated with the network entity, the method further comprising: selecting the channel-specific DMRS scrambling identifier from a plurality of channel-specific DMRS scrambling identifiers that excludes one or more channel-specific DMRS scrambling identifiers associated with one or more neighboring cells of the first cell.
Aspect 25: The method of aspect 24, further comprising: obtaining a cell measurement report including one or more measurements for the first cell and the one or more neighboring cells of the first cell; and outputting, in accordance with the cell measurement report, an indication of the channel-specific DMRS scrambling identifier associated with the first cell.
Aspect 26: The method of any of aspects 24 through 25, further comprising: obtaining an indication of the channel-specific DMRS scrambling identifier via one or more backhaul links associated with the network entity.
Aspect 27: The method of any of aspects 17 through 26, wherein the DCI indicates a scheduling of one or more frequency domain I/Q samples for the PDSCH that spans a portion of a downlink bandwidth part.
Aspect 28: The method of any of aspects 17 through 27, wherein the channel-specific DMRS scrambling identifier comprises a first channel-specific DMRS scrambling identifier associated with the first PDCCH search space the first channel-specific DMRS scrambling identifier is different from the second channel-specific DMRS scrambling identifier based at least in part on the first PDCCH search space and the second PDCCH search space comprising a same PDCCH search space, or based at least in part on the first PDCCH search space and the second PDCCH search space being associated with a same control resource set.
Aspect 29: A UE for wireless communications, comprising one or more memories storing processor-executable code, and one or more processors coupled with the one or more memories and individually or collectively operable to execute the code to cause the UE to perform a method of any of aspects 1 through 16.
Aspect 30: A UE for wireless communications, comprising at least one means for performing a method of any of aspects 1 through 16.
Aspect 31: A non-transitory computer-readable medium storing code for wireless communications, the code comprising instructions executable by one or more processors to perform a method of any of aspects 1 through 16.
Aspect 32: A network entity for wireless communications, comprising one or more memories storing processor-executable code, and one or more processors coupled with the one or more memories and individually or collectively operable to execute the code to cause the network entity to perform a method of any of aspects 17 through 28.
Aspect 33: A network entity for wireless communications, comprising at least one means for performing a method of any of aspects 17 through 28.
Aspect 34: A non-transitory computer-readable medium storing code for wireless communications, the code comprising instructions executable by one or more processors to perform a method of any of aspects 17 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described herein for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described herein in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described herein as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
monitor a first physical downlink control channel (PDCCH) search space and a second PDCCH search space for downlink control information associated with a channel-specific demodulation reference signal (DMRS) scrambling identifier;
receive downlink control information associated with the channel-specific DMRS scrambling identifier according to the monitoring, wherein the downlink control information is received in accordance with a combination of a first downlink control information candidate of the first PDCCH search space and a second downlink control information candidate of the second PDCCH search space; and
receive a physical downlink shared channel (PDSCH) transmission in accordance with the downlink control information.

2. The UE of claim 1, wherein, to monitor the first PDCCH search space and the second PDCCH search space, the one or more processors are individually or collectively operable to execute the code to cause the UE to:
monitor the first PDCCH search space and the second PDCCH search space for remaining minimum system information, wherein the channel-specific DMRS scrambling identifier indicates that the first PDCCH search space and the second PDCCH search space are associated with receiving the remaining minimum system information.

3. The UE of claim 1, wherein the channel-specific DMRS scrambling identifier comprises a first type of DMRS scrambling identifier that indicates remaining minimum system information-specific PDCCH, and the one or more processors are individually or collectively further operable to execute the code to cause the UE to:
monitor a third PDCCH search space for downlink control information associated with a second type of DMRS scrambling identifier that is different from the first type of DMRS scrambling identifier, wherein the second type of DMRS scrambling identifier indicates one or more PDCCHs that are different from the remaining minimum system information-specific PDCCH.

4. The UE of claim 1, wherein the one or more processors are individually or collectively further operable to execute the code to cause the UE to:
determine that the channel-specific DMRS scrambling identifier indicates remaining minimum system information-specific PDCCH in accordance with a correlation between a received DMRS signal sequence and a DMRS sequence associated with the channel-specific DMRS scrambling identifier exceeding a correlation threshold.

5. The UE of claim 1, wherein the first downlink control information candidate and the second downlink control information candidate comprise a subset of downlink control information candidates of a plurality of downlink control information candidates associated with receiving remaining minimum system information, and the channel-specific DMRS scrambling identifier corresponds to the subset of downlink control information candidates.

6. The UE of claim 5, wherein the channel-specific DMRS scrambling identifier corresponds to the subset of downlink control information candidates based at least in part on the downlink control information being received in accordance with the combination of the subset of downlink control information candidates.

7. The UE of claim 1, wherein the one or more processors are individually or collectively further operable to execute the code to cause the UE to:
receive a master information block comprising at least one field that indicates whether first content of the first downlink control information candidate of the first PDCCH search space is identical to second content of the second downlink control information candidate of the second PDCCH search space.

8. The UE of claim 7, wherein the at least one field of the master information block comprises a single bit that indicates whether the first content is identical to the second content.

9. The UE of claim 1, wherein the channel-specific DMRS scrambling identifier comprises a remaining minimum system information PDCCH-specific DMRS scrambling identifier associated with a first cell, and the one or more processors are individually or collectively further operable to execute the code to cause the UE to:
monitor a third PDCCH search space for downlink control information associated with a cell-specific DMRS scrambling identifier associated with a second cell, wherein the remaining minimum system information PDCCH-specific DMRS scrambling identifier is different in value from the cell-specific DMRS scrambling identifier.

10. The UE of claim 9, wherein the remaining minimum system information PDCCH-specific DMRS scrambling identifier is selected from a first set of identifier values and the cell-specific DMRS scrambling identifier is selected from a second set of identifier values, and the first set of identifier values and the second set of identifier values are non-overlapping.

11. The UE of claim 1, wherein the channel-specific DMRS scrambling identifier is associated with a first cell of the UE, and is selected from a plurality of channel-specific DMRS scrambling identifiers that excludes one or more channel-specific DMRS scrambling identifiers associated with one or more neighboring cells of the first cell.

12. The UE of claim 11, wherein the one or more processors are individually or collectively further operable to execute the code to cause the UE to:
transmit a cell measurement report including one or more measurements for the first cell and the one or more neighboring cells of the first cell; and
receive, in accordance with the cell measurement report, an indication of the channel-specific DMRS scrambling identifier associated with the first cell.

13. The UE of claim 1, wherein the one or more processors are individually or collectively further operable to execute the code to cause the UE to:
buffering, prior to combine and decode the first downlink control information candidate and the second downlink control information candidate, one or more frequency domain in-phase/quadrature (I/Q) samples that are candidates for the PDSCH scheduled by the first downlink control information candidate or the second downlink control information candidate.

14. The UE of claim 13, wherein the first downlink control information candidate, the second downlink control information candidate, or both, indicate a scheduling of the one or more frequency domain I/Q samples for the PDSCH that spans a portion of a downlink bandwidth part.

15. The UE of claim 1, wherein the channel-specific DMRS scrambling identifier comprises a first channel-specific DMRS scrambling identifier associated with the first PDCCH search space, and, to monitor the first PDCCH search space and the second PDCCH search space, the one or more processors are individually or collectively operable to execute the code to cause the UE to:
monitor the first PDCCH search space for downlink control information associated with the first channel-specific DMRS scrambling identifier and the second PDCCH search space for downlink control information associated with a second channel-specific DMRS scrambling identifier, wherein the first channel-specific DMRS scrambling identifier is different from the second channel-specific DMRS scrambling identifier based at least in part on the first PDCCH search space and the second PDCCH search space comprising a same PDCCH search space.

16. The UE of claim 1, wherein the channel-specific DMRS scrambling identifier comprises a first channel-specific DMRS scrambling identifier associated with the first PDCCH search space, and, to monitor the first PDCCH search space and the second PDCCH search space, the one or more processors are individually or collectively operable to execute the code to cause the UE to:
monitor the first PDCCH search space for downlink control information associated with the first channel-specific DMRS scrambling identifier and the second PDCCH search space for downlink control information associated with a second channel-specific DMRS scrambling identifier, wherein the first channel-specific DMRS scrambling identifier is different from the second channel-specific DMRS scrambling identifier based at least in part on the first PDCCH search space and the second PDCCH search space being associated with a same control resource set.

17. A network entity, comprising:
one or more memories storing processor-executable code; and
one or more processors coupled with the one or more memories and individually or collectively operable to execute the code to cause the network entity to:
output, to a user equipment (UE), downlink control information associated with a channel-specific demodulation reference signal (DMRS) scrambling identifier, wherein the downlink control information is output in accordance with a combination of a first downlink control information candidate of a first physical downlink control channel (PDCCH) search space and a second downlink control information candidate of a second PDCCH search space; and
output a physical downlink shared channel (PDSCH) transmission in accordance with the downlink control information.

18. The network entity of claim 17, wherein the channel-specific DMRS scrambling identifier indicates that the first PDCCH search space and the second PDCCH search space are associated with receiving remaining minimum system information.

19. The network entity of claim 17, wherein the channel-specific DMRS scrambling identifier comprises a first type of DMRS scrambling identifier that indicates remaining minimum system information-specific PDCCH, and the one or more processors are individually or collectively further operable to execute the code to cause the network entity to:
output downlink control information associated with a second type of DMRS scrambling identifier that is different from the first type of DMRS scrambling identifier, wherein the second type of DMRS scrambling identifier indicates one or more PDCCHs that are different from the remaining minimum system information-specific PDCCH.

20. The network entity of claim 17, wherein the first downlink control information candidate and the second downlink control information candidate comprise a subset of downlink control information candidates of a plurality of downlink control information candidates associated with outputting remaining minimum system information, and the channel-specific DMRS scrambling identifier corresponds to the subset of downlink control information candidates.

21. The network entity of claim 20, wherein the channel-specific DMRS scrambling identifier corresponds to the subset of downlink control information candidates based at least in part on the downlink control information being output in accordance with the combination of the subset of downlink control information candidates.

22. The network entity of claim 17, wherein the one or more processors are individually or collectively further operable to execute the code to cause the network entity to:
output a master information block comprising at least one field that indicates whether first content of the first downlink control information candidate of the first PDCCH search space is identical to second content of the second downlink control information candidate of the second PDCCH search space, wherein the at least one field of the master information block comprises a single bit that indicates whether the first content is identical to the second content.

23. The network entity of claim 17, wherein the channel-specific DMRS scrambling identifier comprises a remaining minimum system information PDCCH-specific DMRS scrambling identifier associated with a first cell, and the remaining minimum system information PDCCH-specific DMRS scrambling identifier is different in value from a cell-specific DMRS scrambling identifier associated with a second cell.

24. The network entity of claim 17, wherein the channel-specific DMRS scrambling identifier is associated with a first cell associated with the network entity, and the one or more processors are individually or collectively further operable to execute the code to cause the network entity to:
select the channel-specific DMRS scrambling identifier from a plurality of channel-specific DMRS scrambling identifiers that excludes one or more channel-specific DMRS scrambling identifiers associated with one or more neighboring cells of the first cell.

25. The network entity of claim 24, wherein the one or more processors are individually or collectively further operable to execute the code to cause the network entity to:
obtain a cell measurement report including one or more measurements for the first cell and the one or more neighboring cells of the first cell; and
output, in accordance with the cell measurement report, an indication of the channel-specific DMRS scrambling identifier associated with the first cell.

26. The network entity of claim 24, wherein the one or more processors are individually or collectively further operable to execute the code to cause the network entity to:
obtain an indication of the channel-specific DMRS scrambling identifier via one or more backhaul links associated with the network entity.

27. The network entity of claim 17, wherein the downlink control information indicates a scheduling of one or more frequency domain in-phase/quadrature (I/Q) samples for the PDSCH that spans a portion of a downlink bandwidth part.

28. The network entity of claim 17, wherein the channel-specific DMRS scrambling identifier comprises a first channel-specific DMRS scrambling identifier associated with the first PDCCH search space, and the first channel-specific DMRS scrambling identifier is different from the second channel-specific DMRS scrambling identifier based at least in part on the first PDCCH search space and the second PDCCH search space comprising a same PDCCH search space, or based at least in part on the first PDCCH search space and the second PDCCH search space being associated with a same control resource set.

29. A method for wireless communications at a user equipment (UE), comprising:
monitoring a first physical downlink control channel (PDCCH) search space and a second PDCCH search space for downlink control information associated with a channel-specific demodulation reference signal (DMRS) scrambling identifier;
receiving downlink control information associated with the channel-specific DMRS scrambling identifier according to the monitoring, wherein the downlink control information is received in accordance with a combination of a first downlink control information candidate of the first PDCCH search space and a second downlink control information candidate of the second PDCCH search space; and
receiving a physical downlink shared channel (PDSCH) transmission in accordance with the downlink control information.

30. A method for wireless communications at a network entity, comprising:
outputting, to a user equipment (UE), downlink control information associated with a channel-specific demodulation reference signal (DMRS) scrambling identifier, wherein the downlink control information is output in accordance with a combination of a first downlink control information candidate of a first physical downlink control channel (PDCCH) search space and a second downlink control information candidate of a second PDCCH search space; and
outputting a physical downlink shared channel (PDSCH) transmission in accordance with the downlink control information.
